(19) United States
(12) Patent Application Publication
(10) Pub. No.: US 2012/0268694 A1
(43) Pub. Date: Oct. 25, 2012

(54) CELLULOSE ACYLATE FILM, METHOD FOR PRODUCING SAME, POLARIZER AND LIQUID CRYSTAL DISPLAY DEVICE

(75) Inventors: Jun TAKEDA, Kanagawa (JP); Yoji ITO, Kanagawa (JP)

(73) Assignee: FUJIFILM CORPORATION, Tokyo (JP)

(21) Appl. No.: 13/453,460

(22) Filed: Apr. 23, 2012

(30) Foreign Application Priority Data
Apr. 21, 2011 (JP) 2011-095486

(51) Int. Cl. G02F 1/1335; G02B 5/30; B32B 5/00

(52) U.S. Cl. 349/96; 428/220; 359/483.01

(57) ABSTRACT

A cellulose acylate film, which comprises a cellulose acylate having a total degree of substitution of from 2.1 to 2.3 and a non-phosphate compound, which satisfies the following formulae (1) and (2), and which has a thickness of from 10 μm to 45 μm, has desired optical expressibility, small internal haze, and curling resistance when used in polarizer, and, when mounted in liquid crystal display devices, is capable of significantly solving the problem of color shift and corner unevenness on the display panel:

40 nm≦Re(550)≦60 nm (1)

100 nm≦Rth(550)≦300 nm (2)

### CROSS-REFERENCE TO RELATED APPLICATIONS

The present application claims the benefit of priority from Japanese Patent Application No. 2011-095486, filed on Apr. 21, 2011, the contents of which are herein incorporated by reference in their entirety.

### BACKGROUND OF THE INVENTION

1. Field of the Invention

The present invention relates to a cellulose acylate film and its production method, and to a polarizer and a liquid crystal display device comprising the cellulose acylate film. In particular, the invention relates to a cellulose acylate film favorable for use as an optical film such as a polarizer protective film, an optical compensatory film, etc.

2. Description of the Related Art

With the recent tendency toward advancing TV use of liquid crystal display devices, the panel size of the devices is enlarged and high-definition and low-price liquid crystal display devices are much desired. In particular, VA-mode liquid crystal display devices have a relatively high contrast and enjoy a relatively high production yield, and are therefore most popular liquid crystal display devices for TV use.

However, VA-mode liquid crystal display devices have a problem in that, at the time of black level of display, the devices could provide black that is good in some degree in the normal direction to the display panel, but when the black level panel is watched in viewing angle directions (oblique directions), there occurs light leakage to disable background black display whereby the viewing angle is narrowed. Accordingly, a retardation film is desired capable of expressing a retardation level in such a degree that enables viewing angle compensation.

Recently, further, for preventing the neutral tone on a liquid crystal display panel from being yellowed, a multigap (MG) cell has become used in which the thickness of the liquid crystal layer, or that is, the cell gap is changed for every color. However, the multigap cell is problematic in that, as compared with that on a conventional liquid crystal display panel, the color shift at the time of black level of display in viewing angle directions increases, and therefore, it has become much desired to further improve the multigap cell in point of preventing the color shift at the time of black level of display in viewing angle directions on a liquid crystal display panel.

Regarding this, Patent Reference 1 describes a cellulose acylate film that is thick in some degree and, when incorporated in a liquid crystal display device, is capable of enhancing the contrast of the display panel and removing the problem of color shift thereof.

On the other hand, the demand for use of liquid crystal display devices in various environments has become increased, and in particular, the demand for favorable use thereof in wet heat environments, for example, for outdoor use thereof has increased. In case where liquid crystal display devices are used in wet heat environments, the polarizer therein may curve and there may occur corner unevenness on the display panel, and therefore, it is desired to provide a film capable of solving the problems.

Recently, the demand for slate PC has increased, and thinner and lighter displays have become desired, and consequently, thinner retardation films have become desired.

### CITATION LIST

### Patent Reference

Patent Reference 1: US 2010-0271574A1

### SUMMARY OF THE INVENTION

The present inventors investigated the film described in Patent Reference 1 and have known that, when the film is mounted on a liquid crystal display device, there still occurs the problem of corner unevenness on the display panel. In addition, the inventors have known that the films described in Examples in the patent reference are still problematic and are desired to be improved in point of the thickness reduction thereof.

An object of the invention is to provide a cellulose acylate film having the advantages of desired optical expressibility even though thin, small internal haze, and curling resistance when used in polarizer, and, when mounted in liquid crystal display devices, capable of significantly solving the problem of color shift and corner unevenness on the display panel.

With the above-mentioned objects, the inventors have assiduously studied and, as a result, have found that a cellulose acylate film in which a specific additive is added to the cellulose acylate having a total degree of acylation falling within a specific range and of which the thickness is reduced so as to have controlled optical expressibility within a specific range can solve the above-mentioned problems and have completed the present invention.

Concretely, the inventors have attained the objects according to the following means:

[1] A cellulose acylate film, which comprises a cellulose acylate having a total degree of substitution of from 2.1 to 2.3 and a non-phosphate compound, which satisfies the following formulae (1) and (2), and which has a thickness of from 10 μm to 45 μm:

40 nm≦Re(550)≦60 nm (1)

wherein Re(550) means the in-plane retardation of the film at a wavelength of 550 nm,

100 nm≦Re(550)≦300 nm (2)

wherein Rth(550) means the thickness-direction retardation of the film at a wavelength of 550 nm.
[2] The cellulose acylate film of [1], having a thickness of from 15 μm to 30 μm.
[3] The cellulose acylate film of [1] or [2], of which the absolute value of the dimensional change satisfies the following formula (3):

|{(L′−L0)/L0}×100%|0.5% (3)

wherein L0 means the length (unit: mm) of the film before aged for 24 hours at 60° C. and at a relative humidity of 90%; and L′ means the length (unit: mm) of the film after aged for 24 hours at 60° C. and at a relative humidity of 90% and further after conditioned for 2 hours.
[4] The cellulose acylate film of any one of [1] to [3], wherein the absolute value of the difference between the SP value of the cellulose acylate and the SP value of the non-phosphate compound is at most 1.5 MPa^{1/2} and wherein the SP value indicates the solubility parameter measured according to a Hoy method.
[5] The cellulose acylate film of any one of [1] to [4], comprising a hydrophobizing agent as the non-phosphate compound.
[6] The cellulose acylate film of [5], comprising, as the hydrophobizing agent, at least one additive selected from sugars, polycondensate ester compounds and nitrogen-containing compounds.
[7] The cellulose acylate film of any one of [1] to [6], wherein the cellulose acylate is a cellulose acetate.
[8] The cellulose acylate film of any one of [1] to [7], stretched at a stretching temperature of from 130 to 195° C.
[9] The cellulose acylate film of any one of [1] to [8], stretched at a draw ratio falling within a range of from more than 15% to less than 35%.
[10] The cellulose acylate film of any one of [1] to [9], processed for wet heat treatment at a wet heat treatment temperature of from 80 to 120° C. and at an absolute humidity of from 150 to 380 g/m³.
[11] A polarizer comprising a polarizing element and the cellulose acylate film of any one of [1] to [10] on at least one side of the polarizing element.
[12] A liquid crystal display device comprising at least one polarizer of [11].

According to the invention, there is provided a cellulose acylate film having the advantages of desired optical expressibility even though thin, small internal haze, and curling resistance when used in polarizer, and, when mounted in liquid crystal display devices, capable of significantly solving the problem of color shift and corner unevenness on the display panel.

### BRIEF DESCRIPTION OF THE DRAWING

FIG. 1 is a schematic cross-sectional view of one example of a VA-mode liquid crystal display device of the invention. In the drawing, 11 and 12 are polarizing element, 13 is liquid crystal cell, and 14 and 15 are cellulose acylate film of Examples and Comparative Examples.

### DESCRIPTION OF THE PREFERRED EMBODIMENTS

The contents of the invention are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof. In this description, “front side” means the panel side of the display device, and “rear side” means the backlight side thereof. In this description, “front” means the normal direction to the panel of the display device, and “front contrast (hereinafter “contrast” may be referred to as CR)” means the contrast as computed from the brightness at the time of white level of display and the brightness at the time of black level of display measured in the normal direction to the display panel.

### [Cellulose Acylate Film]

The cellulose acylate film of the invention (hereinafter this may be referred to as “the film of the invention”) comprises a cellulose acylate having a total degree of substitution of from 2.1 to 2.3 and a non-phosphate compound, which satisfies the following formulae (1) and (2), and which has a thickness of from 10 μm to 45 μm:

40 nm≦Re(550)≦60 nm (1)

wherein Re(550) means the in-plane retardation of the film at a wavelength of 550 nm,

100 nm≦Rth(550)≦300 nm (2)

wherein Rth(550) means the thickness-direction retardation of the film at a wavelength of 550 nm.

The film of the invention is described below.

### <Cellulose Acylate>

The film of the invention contains a cellulose acylate having a total degree of substitution of from 2.1 to 2.3. The cellulose acylate for use in the invention is described below.

The starting cellulose for the cellulose acylate for use in the invention includes cotton linter and wood pulp (hardwood pulp, softwood pulp), etc.; and any cellulose obtained from any starting cellulose can be used herein. As the case may be, different starting celluloses may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8. Cellulose materials described in these may be used for the cellulose acylate film for the invention with no specific limitation.

The cellulose acylate preferably used in the invention is described in detail. The β-1,4-bonding glucose unit to constitute cellulose has a free hydroxyl group at the 2-, 3- and 6-positions. The cellulose acylate is a polymer produced by esterifying a part or all of those hydroxyl groups in cellulose with an acyl group. The degree of acyl substitution means the total of the ratio of acylation of the hydroxyl group in cellulose positioned in the 2-, 3- and 6-positions in the unit therein. In case where the hydroxyl group is 100% esterified at each position, the degree of substitution at that position is 1.

Only one or two or more different types of acyl groups may be used, either singly or as combined, in the cellulose acylate for use in the invention.

Not specifically defined, the acyl group in the cellulose acylate for use in the invention may be an aliphatic group or an aryl group. For example, the ester is an alkylcarbonyl ester, an alkenylcarbonyl ester, an aromatic carbonyl ester or an aromatic alkylcarbonyl ester of cellulose, in which the acyl group may be further substituted. Preferred examples of the acyl group include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a tert-butanoyl group, a cyclohexanecarbonyl group, an oleoyl group, a benzoyl group, a naphthylcarbonyl group, a cinnamoyl group, etc. Of those, preferred are an acetyl group, a propionyl group, a butanoyl group, a dodecanoyl group, an octadecanoyl group, a tert-butanoyl group, an oleoyl group, a benzoyl group, a naphthylcarbonyl group, and a cinnamoyl group; more preferred are an acetyl group, a propionyl group and a butanoyl group (acyl group having from 2 to 4 carbon atoms). Even more preferred is an acetyl group (in this case, the cellulose acylate is a cellulose acetate).

The cellulose acylate includes triacetyl cellulose (TAC), diacetyl cellulose (DAC), cellulose acetate propionate (CAP), cellulose acetate butyrate (CAB), cellulose acetate phthalate, etc. Preferably, in the cellulose acylate film of the invention, all the acyl groups in the cellulose acylate are acetyl groups from the viewpoint of the retardation expressibility and the cost of the film.

The film of the invention contains a cellulose acylate having a total degree of substitution of from 2.1 to 2.3. Preferably, the total degree of acyl substitution of the cellulose acylate is from 2.13 to 2.28, more preferably from 2.15 to 2.25.

The degree of acyl substitution may be determined according to the method stipulated in ASTM-D817-96. The part not substituted with an acyl group is generally a hydroxyl group.

In the invention, even a cellulose acylate film that contains a cellulose acylate having such a low degree of acyl substitution could be improved in the dimensional stability under wet heat conditions, and therefore in the invention, a cellulose acylate film that contains such a cellulose acylate having a low degree of acyl substitution can be produced.

The cellulose acylate can be produced in known methods. For example, it can be produced according to the method described in JP-A 10-45804.

In case where an acid anhydride or an acid chloride is used as the acylating agent for acylation of cellulose, an organic acid such as acetic acid, or methylene chloride or the like may be used as the organic solvent to be the reaction solvent.

In case where the acylating agent is an acid anhydride, the catalyst is preferably a protic catalyst such as sulfuric acid; and in case where the acylating agent is an acid chloride (e.g., CH₃CH₂COCl), a basic compound may be used as the catalyst.

A most popular industrial-scale production method for a mixed fatty acid ester of cellulose comprises acylating cellulose with a mixed organic acid component that contains a fatty acid (e.g., acetic acid, propionic acid, valeric acid) corresponding to an acetyl group or other acyl group, or its acid anhydride.

Preferably, the molecular weight of the cellulose acylate is from 40000 to 200000 in terms of the number-average molecular weight (Mn) thereof, more preferably from 100000 to 200000. Also preferably, the ratio of Mw/Mn of the cellulose acylate for use in the invention is at most 4.0, more preferably from 1.4 to 2.3.

In the invention, the mean molecular weight and the molecular weight distribution of cellulose acylate and others may be determined by measuring the number-average molecular weight (Mn) and the weight-average molecular weight (Mw) thereof through gel permeation chromatography (GPC) followed by computing the ratio of the resulting data according to the method described in WO2008-126535.

### <Non-Phosphate Compound>

The film of the invention contains a non-phosphate compound from the viewpoint of satisfying both retardation expression and haze reduction.

The non-phosphate compound is preferably a hydrophobizing agent. Preferably, the hydrophobizing agent is one capable of reducing the water content of the film not lowering the glass transition temperature thereof as much as possible. As the hydrophobizing agent for use in the invention, for example, preferred are phthalate-type plasticizers, trimellitate-type plasticizers, pyromellitate-type plasticizers, polyalcohol-type plasticizers, glycolate-type plasticizers, citrate-type plasticizers, sugars (preferably, sugar ester compounds), polyester-type plasticizers (polycondensate ester compounds such as fatty acid-ended polyester-type plasticizers, aromatic ring-containing polyester-type plasticizers, etc.), carboxylate-type plasticizers, acrylic polymers, nitrogen-containing compounds (preferably nitrogen-containing aromatic compounds), etc. More preferably, the hydrophobizing agent contains at least one additive selected from sugars, polycondensate ester compounds and nitrogen-containing compounds.

The non-phosphate compound may be a low-molecular compound or a polymer (high-molecular compound). The polymer (high-molecular compound) of the non-phosphate compound may be hereinafter referred to as a non-phosphate polymer.

The non-phosphate compound for use in the invention is described below.

As the non-phosphate compound, widely usable here are high-molecular additives and low-molecular additives that are known as additives to cellulose acylate film.

Preferably, the content of the non-phosphate compound is from 0 to 35% by mass of the cellulose acylate in the film, more preferably from 0 to 18% by mass, even more preferably from 0 to 15% by mass.

The high-molecular additive usable as the non-phosphate compound in the film of the invention has a recurring unit in the compound, and is preferably one having a number-average molecular weight of from 700 to 10000. The high-molecular additive has the function of accelerating the evaporation speed of solvent and reducing the residual solvent amount in solution-casting film formation. Further, from the viewpoint of film modification for enhancing the mechanical properties, imparting flexibility, imparting water absorption resistance and reducing the moisture permeability, the additive exhibits useful effects.

The number-average molecular weight of the non-phosphate compound of high-molecular additive is more preferably from 700 to 8000, even more preferably from 700 to 5000, still more preferably from 1000 to 5000.

The non-phosphate compound of high-molecular additive for use in the invention is described below with reference to specific examples thereof given below; needless-to-say, however, the non-phosphate compound of high-molecular additive for use in the invention is not limited to these.

Preferably, the non-phosphate compound is a non-phosphate ester compound.

The non-phosphate compound of high-molecular additive includes polyester polymers (aliphatic polyester polymers, aromatic polyester polymers, etc.), copolymers of a polyester ingredient and any other ingredient, etc. Preferred are aliphatic polyester polymers, aromatic polyester polymers, copolymers of a polyester polymer (aliphatic polyester polymer, aromatic polyester polymer or the like) and an acrylic polymer, and copolymers of a polyester polymer (aliphatic polyester polymer, aromatic polyester polymer or the like) and a styrenic polymer; and more preferred are polyester compounds containing at least one aromatic ring as the copolymerization ingredient thereof.

As the non-phosphate compound for use in the invention, preferred is use of polycondensate ester compounds not causing haze in the film and not bleeding out or evaporating out of the film. More preferred are polyester-type plasticizers having a number-average molecular weight of from 300 to less than 2000.

Not specifically defined, the polyester-type plasticizers are preferably those having an aromatic ring or a cycloalkyl ring in the molecule thereof.

For example, preferred are aromatic ring-ended polyester-type plasticizers represented by the following general formula (2):

B¹-(G¹-A¹)n-G¹-B¹ (2)

wherein B¹ represents a benzenemonocarboxylic acid residue; G¹ represents an alkylene glycol residue having from 2 to 12 carbon atoms, or an arylglycol residue having from 6 to 12 carbon atoms, or an oxyalkylene glycol residue having from 4 to 12 carbon atoms; A¹ represents an alkylenedicarboxylic acid residue having from 4 to 12 carbon atoms, or an aryldicarboxylic acid residue having from 6 to 12 carbon atoms; and n indicates an integer of 1 or more.

The general formula (2) is composed of a benzenemonocarboxylic acid residue of B¹, an alkylene glycol residue, an oxyalkylene glycol residue or an arylglycol residue of G¹, and an alkylenedicarboxylic acid residue or an aryldicarboxylic acid residue of A¹.

The benzenemonocarboxylic acid ingredient of the polyester-type plasticizer for use in the invention includes, for example, benzoic acid, para-tertiary butyl-benzoic acid, orthotoluic acid, metatoluic acid, paratoluic acid, dimethylbenzoic acid, ethylbenzoic acid, normal propylbenzoic acid, aminobenzoic acid, acetoxybenzoic acid, and one or more of these may be used here either singly or as combined.

The alkylene glycol ingredient having from 2 to 12 carbon atoms of the polyester-type plasticizer preferred for use in the invention includes ethylene glycol, 1,2-propylene glycol, 1,3-propylene glycol, 1,2-butanediol, 1,3-butanediol, 1,2-propanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, etc. One or more these glycols may be used here either singly or as combined.

Especially preferred are alkylene glycol having from 2 to 12 carbon atoms, as excellent in miscibility with cellulose acylate.

Preferred alkylene glycols are ethylene glycol (1,2-ethanediol), propylene glycol (1,2-propanediol, 1,3-propanediol), 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol, 1,4-cyclohexanediemthanol; more preferred are ethylene glycol (1,2-ethanediol), propylene glycol (1,2-propanediol, 1,3-propanediol), 1,2-butanediol, 1,3-butanediol, 1,4-butanediol, 1,5-pentanediol, 1,6-hexanediol, 1,4-cyclohexanediol, 1,4-cyclohexanediemthanol; and even more preferred are ethylene glycol (1,2-ethanediol) and propylene glycol (1,2-propanediol, 1,3-propanediol).

The oxyalkylene glycol ingredient having from 4 to 12 carbon atoms of the polyester-type plasticizer for use in the invention includes, for example, diethylene glycol, triethylene glycol, tetraethylene glycol, dipropylene glycol, tripropylene glycol, etc.; and one or more these glycols may be used here either singly or as combined.

The alkylenedicarboxylic acid ingredient having from 4 to 12 carbon atoms of the polyester-type plasticizer for use in the invention includes, for example, succinic acid, maleic acid, fumaric acid, glutaric acid, adipic acid, azelaic acid, sebacic acid, dodecanedicarboxylic acid, etc.; and one or more of these may be used here either singly or as combined.

The arylenedicarboxylic acid having from 6 to 12 carbon atoms includes phthalic acid, terephthalic acid, isophthalic acid, 1,5-naphthalenedicarboxylic acid, 1,4-naphthalenedicarboxylic acid, etc.

Preferred alkylenedicarboxylic acid ingredients of those are malonic acid, succinic acid, maleic acid, fumaric acid, glutaric acid, adipic acid, azelaic acid, 1,4-cyclohexanedicarboxylic acid; and preferred arylenedicarboxylic acids are phthalic acid, terephthalic acid, isophthalic acid, 1,5-naphthalenedicarboxylic acid, 1,4-naphthalenedicarboxylic acid. More preferred alkylenedicarboxylic acid ingredients are succinic acid, glutaric acid, adipic acid; and more preferred arylenedicarboxylic acids are phthalic acid, terephthalic acid, isophthalic acid.

### <<ΔSP Value>>

Preferably in the invention, the absolute value of the difference between the SP value of the cellulose acylate and the SP value of the non-phosphate compound (hereinafter this may be referred to as ΔSP value) is at most 1.5 MPa^{1/2}, wherein the SP value indicates the solubility parameter measured according to a Hoy method.

When the ΔSP value between the cellulose acylate and the non-phosphate compound is at most 1.5, then the miscibility between the cellulose acylate and the additive may better and the film may be prevented from whitening and bleeding. More preferably, the ΔSP value between the cellulose acylate and the non-phosphate compound is at most 1.3, even more preferably less than 1.3, still more preferably less than 1.0.

In case where two or more different types of additives are added to the cellulose acylate film, preferably, the ΔSP value between the additive except non-phosphate compounds and the cellulose acylate satisfies the above-mentioned range.

In case where two or more different types of additives are added to the cellulose acylate film, it is also desirable that, in addition to the ΔSP value between each additive and the cellulose acylate, the ΔSP value between the additives also satisfies the above-mentioned range. For example, in case where two different types of additive are added to the film, preferably, all the three of the difference between the SP value of the non-phosphate compound and the SP value of the cellulose acylate, the difference between the SP value of the second additive and the cellulose acylate and the difference between the SP value of the non-phosphate compound and the second additive satisfy the above-mentioned range. Specifically, it is desirable that the difference between the maximum value and the minimum value of the solubility parameter (SP value) of the above three, as measured according to a Hoy method, satisfies the following formula (2′):

|(SP value(maximum value)−SP value(minimum value)|≦1.5 MPa^{1/2} (2′)

The preferred range of the ΔSP value in the above formula (2′) is the same as the ΔSP value of the above-mentioned cellulose acylate and the above-mentioned non-phosphate compound.

In the invention, the SP value is determined according to a by method. The Hoy method is described in POLYMER HANDBOOK FOURTH EDITION.

Preferably, the polyester-type plasticizer for use in the invention has a number-average molecular weight of from 300 to 1500, more preferably from 400 to 1000.

Preferably, the acid value of the plasticizer is at most 0.5 mg KOH/g, and the hydroxyl value thereof is at most 25 mg KOH/g; and more preferably, the acid value thereof is at most 0.3 mg KOH/g and the hydroxyl value thereof is at most 15 mg KOH/g.

As the polyester-type plasticizer for use in the invention, also preferred are the polymers described in JP-A 2010-46834, [0141]-[0156].

Polycondensation to give the polyester-type plasticizer may be attained in an ordinary method. For example, the polyester-type plasticizer can be readily produced according to (i) a thermal melt condensation method of direct reaction between a dibasic acid and a glycol, or polyesterification or interesterification between the a dibasic acid or its alkyl ester, for example, a methyl ester of a dibasic acid and a glycol, or (ii) a method of dehydrohalogenation between such an acid or acid chloride and a glycol. Preferably, however, the polyester-type plasticizer for use in the invention is produced through direction reaction.

The polyester-type plasticizer having a high distribution on the low-molecular side has an extremely good miscibility with cellulose acylate, and after film formation, the cellulose acylate film formed may have low moisture permeability and is excellent in transparency.

Not specifically defined, the molecular weight of the polymer may be controlled in any known method. For example, depending on the polymerization condition, the molecular weight may be controlled according to an end-capping method of the molecule with a monoacid or a monoalcohol in which the amount of the mono-compound to be added is controlled.

In this case, a monoacid is preferred from the viewpoint of the stability of the polymer. For example, there may be mentioned acetic acid, propionic acid, butyric acid, etc. Monoacids that do not evaporate out from the system during polycondensation reaction but may readily evaporate away from the system after the end-capping reaction are selected, and a mixture of those monoacids may also be used here.

Indirect reaction, the timing for stopping the reaction may be controlled by controlling the amount of water to be generated during the reaction, whereby the number-average molecular weight of the polymer may be controlled. In addition, it may also be controlled by deviating the molar number of the glycol or the dibasic acid to be charged in the reaction, or by controlling the reaction temperature.

The molecular weight of the polyester-type plasticizer for use in the invention may be measured through GPC as above, or according to an end group determination method (hydroxyl value method).

Preferably in the invention, the non-phosphate compound such as the polyester-type plasticizer is contained in the film in an amount of from 1 to 40% by mass of the cellulose acylate therein, more preferably from 5 to 15% by mass.

### (Sugars)

Preferably, the film of the invention contains a sugar compound as the non-phosphate compound, more preferably a sugar ester compound.

Adding a sugar ester compound to the cellulose acylate film does not increase the internal haze of the film through wet heat treatment after stretching and does not detract from the optical characteristics expressibility thereof. Further, when the cellulose acylate film containing such a sugar ester compound is used in liquid crystal display devices, it greatly enhances the front contrast of the display panel.

### —Sugar Residue—

The sugar ester compound means a compound where at least one substitutable group (for example, hydroxyl group, carboxyl group) in the monose or polyose constituting the compound is ester-bonded to at least one substituent therein. Specifically, the sugar ester compound as referred to herein includes sugar derivatives in a broad sense of the word, and for example, includes compounds having a sugar residue as the structural unit thereof such as gluconic acid. Concretely, the sugar ester compound includes an ester of glucose and a carboxylic acid, and an ester of gluconic acid and an alcohol.

The substitutable group in the monose or polyose constituting the sugar ester compound is preferably a hydroxyl group.

The sugar ester compound includes a monose or polyose-derived structure (hereinafter this may be referred to as a sugar residue) that constitutes the sugar ester compound. The structure per monose of the sugar residue is referred to as the structural unit of the sugar ester compound. The structural unit of the sugar ester compound preferably includes a pyranose structural unit or a furanose structural unit, more preferably, all the sugar residues are pyranose structural units or furanose structural units. In case where the sugar ester is formed of a polyose, it preferably includes both a pyranose structural unit and a furanose structural unit.

The sugar residue of the sugar ester compound may be a pentose-derived one or a hexose-derived one, but is preferably a hexose-derived one.

Preferably, the number of the structural units contained in the sugar ester compound is from 1 to 12, more preferably from 1 to 6, even more preferably 1 or 2.

In the invention, preferably, the sugar ester compound contains from 1 to 12 pyranose structural units or furanose structural units in which at least one hydroxyl group is esterified, even more preferably, one or two pyranose structural units or furanose structural units in which at least one hydroxyl group is esterified.

Examples of monoses or polyoses containing from 2 to 12 monose units include, for example, erythrose, threose, ribose, arabinose, xylose, lyxose, arose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, baltopentaose, belbascose, maltohexaose, α-cyclodextrin, β-cyclodextrin, γ-cyclodextrin, δ-cyclodextrin, xylitol, sorbitol, etc.

Preferred are ribose, arabinose, xylose, lyxose, glucose, fructose, mannose, galactose, trehalose, maltose, cellobiose, lactose, sucrose, sucralose, α-cyclodextrin, β-cyclodextrin, γ-cyclodextrin, δ-cyclodextrin, xylitol, sorbitol; more preferred are arabinose, xylose, glucose, fructose, mannose, galactose, maltose, cellobiose, sucrose, β-cyclodextrin, γ-cyclodextrin; and even more preferred are xylose, glucose, fructose, mannose, galactose, maltose, cellobiose, sucrose, xylitol, sorbitol. The sugar ester compound has a glucose skeleton or a sucrose skeleton, which is described in [0059] in JP-A 2009-1696 as the compound 5 therein. The sugar ester compound of the type is, as compared with the sugar ester compound having a maltose skeleton used in Examples in the patent reference, especially preferred from the viewpoint of the compatibility thereof with polymer.

—Structure of Substituent—

More preferably, the sugar ester compound for use in the invention has, including the substituent therein, a structure represented by the following general formula (1):

(OH)ₚ-G-(L¹-R¹¹)_{q}(O—R¹²)ᵣ (1)

wherein G represents a sugar residue; L¹ represents any one of —O—, —CO— or —NR¹³—; R¹¹ represents a hydrogen atom or a monovalent substituent; R¹² represents a monovalent substituent bonding to the formula via an ester bond; p, q and r each independently indicate an integer of 0 or more, and p+q+r is equal to the number of the hydroxyl groups on the presumption that G is an unsubstituted sugar group having a cyclic acetal structure.

The preferred range of G is the same as the preferred range of the above-mentioned sugar residue.

L¹ is preferably —O— or —CO—, more preferably —O—. When L¹ is —O—, it is more preferably an ether bond or an ester bond-derived linking group, even more preferably an ester bond-derived linking group.

In case where the formula has multiple L¹'s, then they may be the same or different.

Preferably, at least one of R¹¹ and R¹² has an aromatic ring.

In particular, in case where L¹ is —O— (or that is, in case where the hydroxyl group in the above-mentioned sugar ester compound is substituted with R¹¹ and R¹²), preferably, R¹¹, R¹² and R¹³ are selected from a substituted or unsubstituted acyl group, a substituted or unsubstituted aryl group, a substituted or unsubstituted alkyl group, or a substituted or unsubstituted amino group, more preferably from a substituted or unsubstituted acyl group, a substituted or unsubstituted alkyl group, or a substituted or unsubstituted aryl group, even more preferably from an unsubstituted acyl group, a substituted or unsubstituted alkyl group, or an unsubstituted aryl group.

In case where the formula has multiple R¹¹'s, R¹²'s and R¹³'s, they may be the same or different.

p is an integer of 0 or more, and its preferred range is the same as the preferred range of the number of the hydroxyl groups per the monose unit to be mentioned below. In the invention, p is preferably 0.

r is preferably a number larger than the number of the pyranose structural units or the furanose structural units contained in G.

q is preferably 0.

p+q+r is equal to the number of the hydroxyl groups on the presumption that G is an unsubstituted sugar group having a cyclic acetal structure, and therefore, the uppermost limit of these p, q and r is specifically defined depending on the structure of G.

Preferred examples of the substituent of the sugar ester compound include an alkyl group (preferably an alkyl group having from 1 to 22 carbon atoms, more preferably from 1 to 12 carbon atoms, even more preferably from 1 to 8 carbon atoms, for example, a methyl group, an ethyl group, a propyl group, a hydroxyethyl group a hydroxypropyl group, a 2-cyanoethyl group, a benzyl group), an aryl group (preferably an aryl group having from 6 to 24 carbon atoms, more preferably from 6 to 18 carbon atoms, even more preferably from 6 to 12 carbon atoms, for example, a phenyl group, a naphthyl group), an acyl group (preferably an acyl group having from 1 to 22 carbon atoms, more preferably from 2 to 12 carbon atoms, even more preferably from 2 to 8 carbon atoms, for example, an acetyl group, a propionyl group, a butyryl group, a pentanoyl group, a hexanoyl group, an octanoyl group, a benzoyl group, a toluoyl group, a phthalyl group), an amide group (preferably an amide group having from 1 to 22 carbon atoms, more preferably from 2 to 12 carbon atoms, even more preferably from 2 to 8 carbon atoms, for example, a formamide group, an acetamide group), an imide group (preferably an imide group having from 4 to 22 carbon atoms, more preferably from 4 to 12 carbon atoms, even more preferably from 4 to 8 carbon atoms, for example, a succinimide group, a phthalimide group), an arylalkyl group (preferably an arylalkyl group having from 7 to 25 carbon atoms, more preferably from 7 to 19 carbon atoms, even more preferably from 7 to 13 carbon atoms, for example, a benzyl group). Of those, more preferred are an alkyl group and an acyl group; and even more preferred are a methyl group, an acetyl group, a benzoyl group and a benzyl group; and especially preferred are an acetyl group and a benzyl group. Especially of those, in case where the constitutive sugar in the sugar ester compound is a sucrose skeleton, preferred are sugar ester compounds having an acetyl group and a benzyl group as the substituents therein, as compared with the sugar ester compound with a benzoyl group described as the compound 3 in [0058] in JP-A 2009-1696 and used in Examples in the patent reference, in point of the compatibility thereof with polymer.

Preferably, the number of the hydroxyl groups per the structural unit in the sugar ester compound (hereinafter this may be referred to as a hydroxyl group content) is at most 3, more preferably at most 1, even more preferably zero (0). Controlling the hydroxyl group content to fall within the range is preferred since the sugar ester compound may be prevented from moving into the adjacent polarizing element layer to break the PVA-iodine complex therein while aged under high temperature and high humidity condition, and therefore the polarizer performance may be prevented from worsening in aging under high temperature and high humidity condition.

Preferably, in the sugar ester compound for use in the film of the invention, an unsubstituted hydroxyl group does not exist and the substituents therein are an acetyl group and/or a benzyl group alone.

Regarding the proportion of the acetyl group and the benzyl group in the sugar ester compound, preferably, the proportion of the benzyl group is smaller in some degree. This is because the wavelength dispersion characteristics of retardation of the cellulose acylate film of the type, ΔRe and ΔRe/Re(550) may increase and, when the film is incorporated in a liquid crystal display device, the color shift at the time of black level of display could be small. Concretely, the ratio of the benzyl group to the sum total of all the unsubstituted hydroxyl groups and all the substituents in the sugar ester compound is preferably at most 60%, more preferably at most 40%.

The sugar ester compounds are available as commercial products such as Tokyo Chemical's ones, Aldrich's ones, etc., or may be produced according to known methods of converting commercially-available carbohydrates into ester derivatives thereof (for example, according to the method described in JP-A 8-245678).

Preferably, the sugar ester compound has a number-average molecular weight of from 200 to 3500, more preferably from 200 to 3000, even more preferably from 250 to 2000.

Specific examples of the sugar ester compounds preferred for use in the invention are mentioned below; however, the invention is not limited to the following embodiments.

In the structural formulae mentioned below, R each independently represents an arbitrary substituent, and plural R's may be the same or different.

TABLE 1

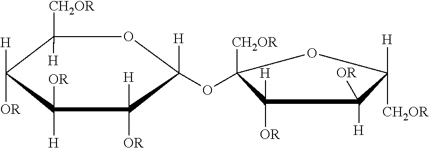

| | Substituent 1 | | Substituent 2 | | |
|---|---|---|---|---|---|
| | | degree | | degree | |
| | | of | | of | Molec- |
| Com- | | substi- | | substi- | ular |
| pound | type | tution | type | tution | Weight |
| 100 | acetyl | 8 | benzyl | 0 | 679 |
| 101 | acetyl | 7 | benzyl | 1 | 727 |
| 102 | acetyl | 6 | benzyl | 2 | 775 |
| 103 | acetyl | 5 | benzyl | 3 | 817 |
| 104 | acetyl | 0 | benzyl | 8 | 1063 |
| 105 | acetyl | 7 | benzoyl | 1 | 741 |
| 106 | acetyl | 6 | benzoyl | 2 | 802 |
| 107 | benzyl | 2 | no | 0 | 523 |
| 108 | benzyl | 3 | no | 0 | 613 |
| 109 | benzyl | 4 | no | 0 | 702 |
| 110 | acetyl | 7 | phenyl- | 1 | 771 |
| | | | acetyl | | |
| 111 | acetyl | 6 | phenyl- | 2 | 847 |
| | | | acetyl | | |

TABLE 2

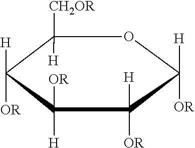

| | Substituent 1 | | Substituent 2 | | |
|---|---|---|---|---|---|
| Com- | | degree of | | degree of | Molecular |
| pound | type | substitution | type | substitution | Weight |
| 201 | acetyl | 4 | benzoyl | 1 | 468 |
| 202 | acetyl | 3 | benzoyl | 2 | 514 |
| 203 | acetyl | 2 | benzoyl | 3 | 577 |
| 204 | acetyl | 4 | benzyl | 1 | 454 |
| 205 | acetyl | 3 | benzyl | 2 | 489 |
| 206 | acetyl | 2 | benzyl | 3 | 535 |
| 207 | acetyl | 4 | phenylacetyl | 1 | 466 |
| 208 | acetyl | 3 | phenylacetyl | 2 | 543 |
| 209 | acetyl | 2 | phenylacetyl | 3 | 619 |
| 210 | phenylacetyl | 1 | no | 0 | 298 |
| 211 | phenylacetyl | 2 | no | 0 | 416 |
| 212 | phenylacetyl | 3 | no | 0 | 535 |
| 213 | phenylacetyl | 4 | no | 0 | 654 |

TABLE 3

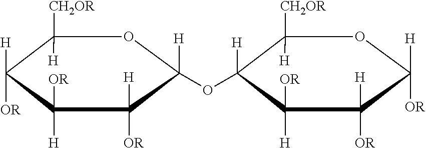

| | Substituent 1 | | Substituent 2 | | |
|---|---|---|---|---|---|
| Com- | | degree of | | degree of | Molecular |
| pound | type | substitution | type | substitution | Weight |
| 301 | acetyl | 6 | benzoyl | 2 | 803 |
| 302 | acetyl | 6 | benzyl | 2 | 775 |
| 303 | acetyl | 6 | phenyl- | 2 | 831 |
| | | | acetyl | | |
| 304 | benzoyl | 2 | no | 0 | 551 |
| 305 | benzyl | 2 | no | 0 | 522 |
| 306 | phenyl- | 2 | no | 0 | 579 |
| | acetyl | | | | |

TABLE 4

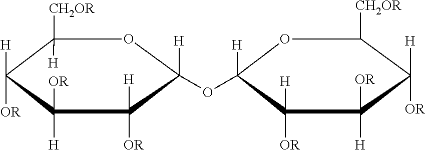

| | Substituent 1 | | Substituent 2 | | |
|---|---|---|---|---|---|
| | | degree of | | degree of | Molecular |
| Compound | type | substitution | type | substitution | Weight |
| 401 | acetyl | 6 | benzoyl | 2 | 803 |
| 402 | acetyl | 6 | benzyl | 2 | 775 |
| 403 | acetyl | 6 | phenylacetyl | 2 | 831 |
| 404 | benzoyl | 2 | no | 0 | 551 |
| 405 | benzyl | 2 | no | 0 | 523 |
| 406 | phenyl | 2 | no | 0 | 579 |
| | ester | | | | |

Preferably, the film in the invention contains the sugar ester compound in an amount of from 2 to 30% by mass relative to the cellulose acylate therein, more preferably from 5 to 20% by mass, even more preferably from 5 to 15% by mass.

### (Nitrogen-Containing Compound)

The film of the invention preferably contains a nitrogen-containing compound as the non-phosphate compound, more preferably a nitrogen-containing aromatic compound.

The nitrogen-containing aromatic compound has, as the mother nucleus thereof, any of pyridine, pyrimidine, triazine or purine and having, as a substituent to be at any substitutable position of the mother nucleus, any of an alkyl group, an alkenyl group, an alkynyl group, an amino group, an amide group (this means a structure of an acyl group bonding to the compound via an amide bond), an aryl group, an alkoxy group, a thioalkoxy group, an alkyl or arylthio group (an alkyl group or an aryl group bonding to the compound via a sulfur atom), or a heterocyclic group. The substituent of the mother nucleus of the nitrogen-containing aromatic compound may be further substituted with any other substituent, and the other substituent is not specifically defined. For example, in case where the mother nucleus is substituted with an amino group, the amino group may be substituted with an alkyl group or alkyl groups (in which the alkyl groups may bond to each other to form a ring), or with —SO₂R′ (R′ means a substituent).

The film of the invention may contain a retardation enhancer to be mentioned below as the nitrogen-containing aromatic compound.

Specific examples of the nitrogen-containing aromatic compound are mentioned below, to which, however, the invention should not be restricted.

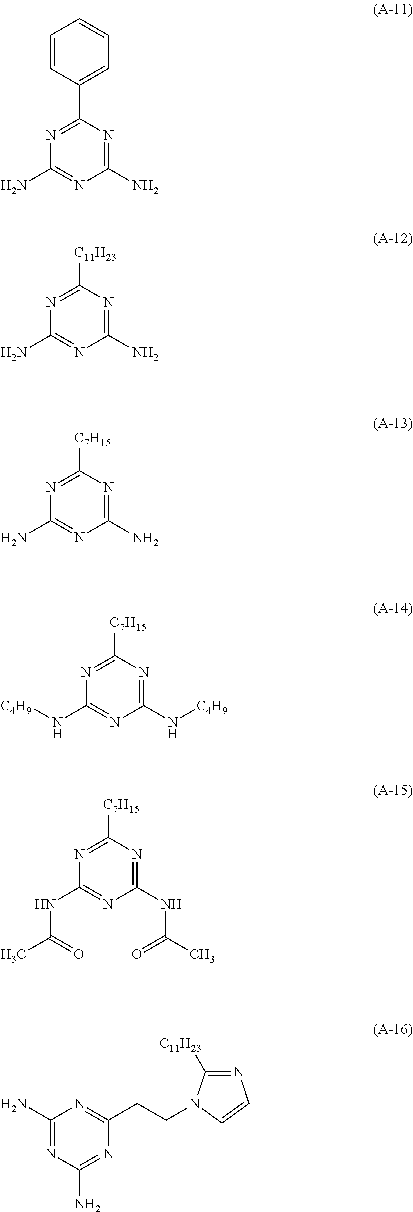

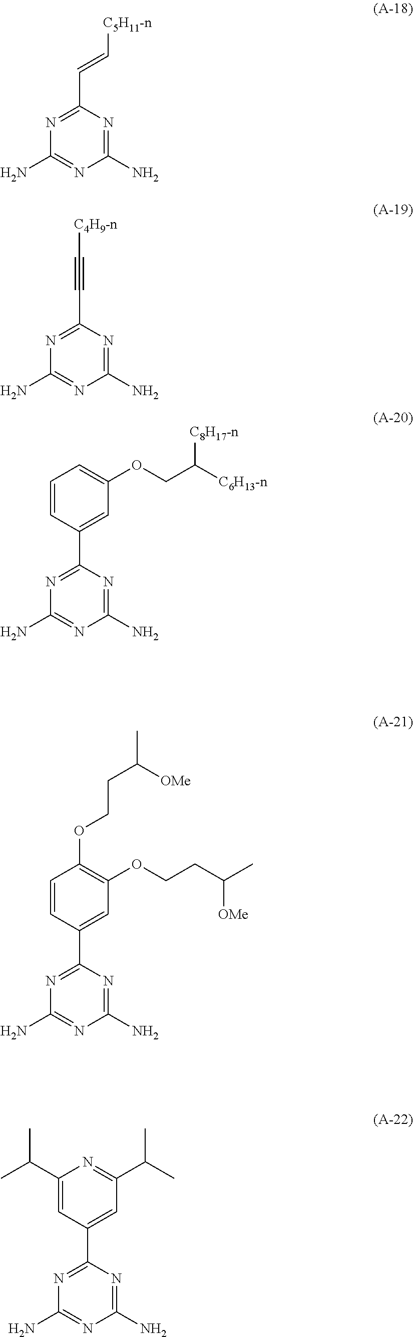

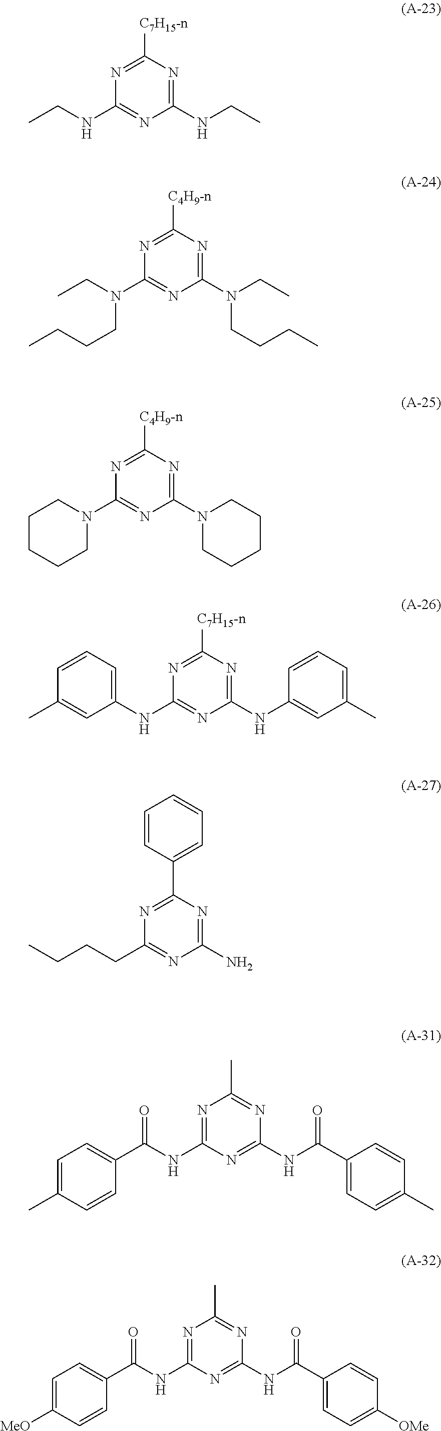

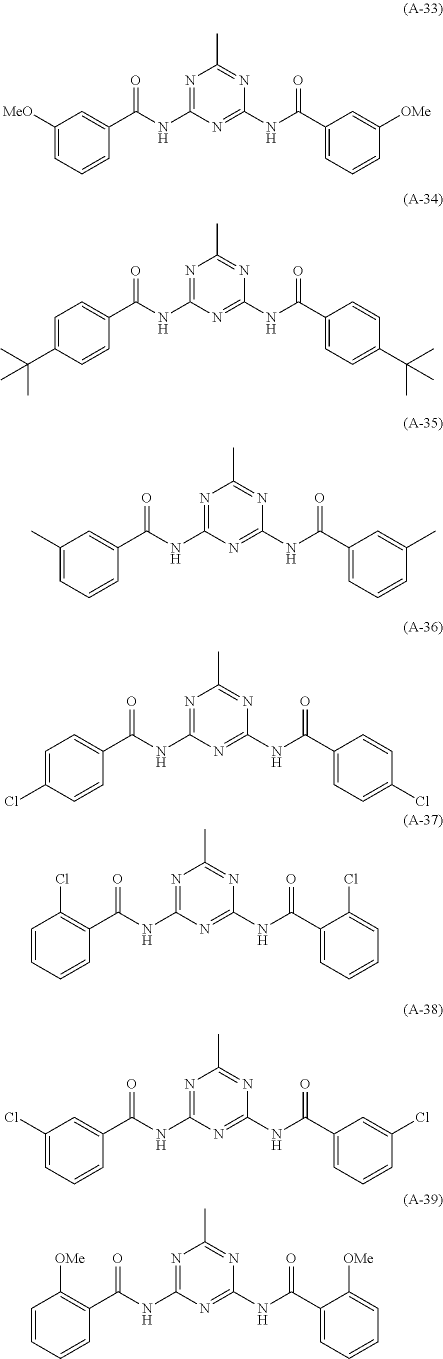

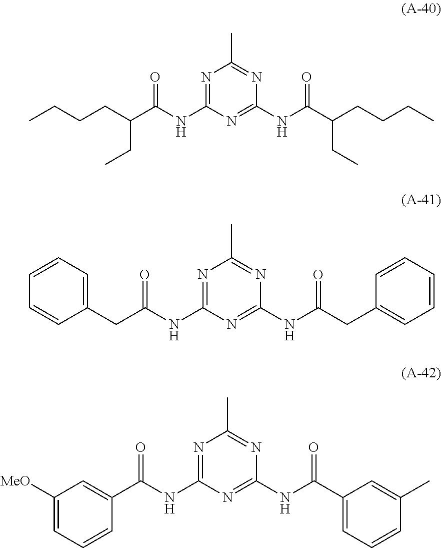

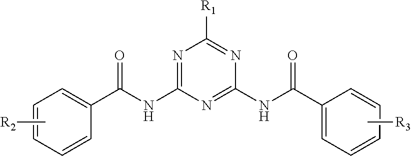

wherein R¹ to R³ are R¹ to R³, respectively, in the following compounds C-101 to C-180.

| Compound | R¹ | R² | R³ |
|---|---|---|---|
| C-101 C-102 C-103 C-104 C-105 C-106 C-107 C-108 C-109 C-110 | 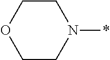 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-111 C-112 C-113 C-114 C-115 C-116 C-117 C-118 C-119 C-120 | 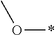 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-121 C-122 C-123 C-124 C-125 C-126 C-127 C-128 C-129 C-130 | 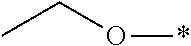 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-131 C-132 C-133 C-134 C-135 C-136 C-137 C-138 C-139 C-140 | 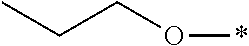 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-141 | H₂N—* | H | H |
| C-142 | | o-Me | o-Me |
| C-143 | | m-Me | m-Me |
| C-144 | | p-Me | p-Me |
| C-145 | | o-OMe | o-OMe |
| C-146 | | m-OMe | m-OMe |
| C-147 | | p-OMe | p-OMe |
| C-148 | | p-t-Bu | p-t-Bu |
| C-149 | | m-Cl | m-Cl |
| C-150 | | m-F | m-F |
| C-151 C-152 C-153 C-154 C-155 C-156 C-157 C-158 C-159 C-160 | 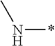 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-161 C-162 C-163 C-164 C-165 C-166 C-167 C-168 C-169 C-170 | 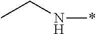 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |
| C-171 C-172 C-173 C-174 C-175 C-176 C-177 C-178 C-179 C-180 | 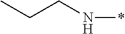 | H o-Me m-Me p-Me o-OMe m-OMe p-OMe p-t-Bu m-Cl m-F | H o-Me m-Me p-Me o-OMe m-OMe p-OMe p-t-Bu m-Cl m-F |

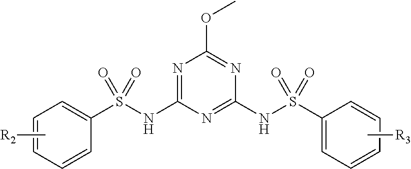

wherein R¹ to R³ are R¹ to R³, respectively, in the following compounds C-181 to C-190.

| Compound | R² | R³ |
|---|---|---|
| C-181 | H | H |
| C-182 | o-Me | o-Me |
| C-183 | m-Me | m-Me |
| C-184 | p-Me | p-Me |
| C-185 | o-OMe | o-OMe |
| C-186 | m-OMe | m-OMe |
| C-187 | p-OMe | p-OMe |
| C-188 | p-t-Bu | p-t-Bu |
| C-189 | m-Cl | m-Cl |
| C-190 | m-F | m-F |

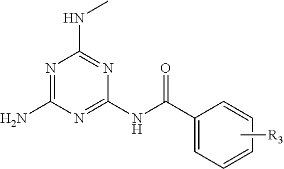

wherein R³ is R³ in the following compounds D-101 to D-110.

| Compound | R³ |
|---|---|
| D-101 | H |
| D-102 | o-Me |
| D-103 | m-Me |
| D-104 | p-Me |
| D-105 | o-OMe |
| D-106 | m-OMe |
| D-107 | p-OMe |
| D-108 | p-t-Bu |
| D-109 | m-Cl |
| D-110 | m-F |

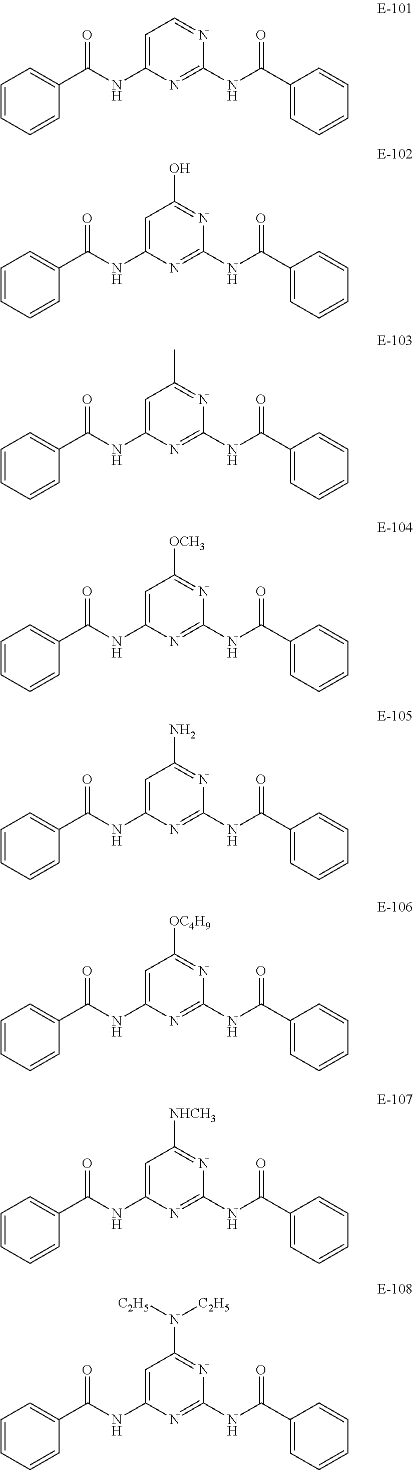

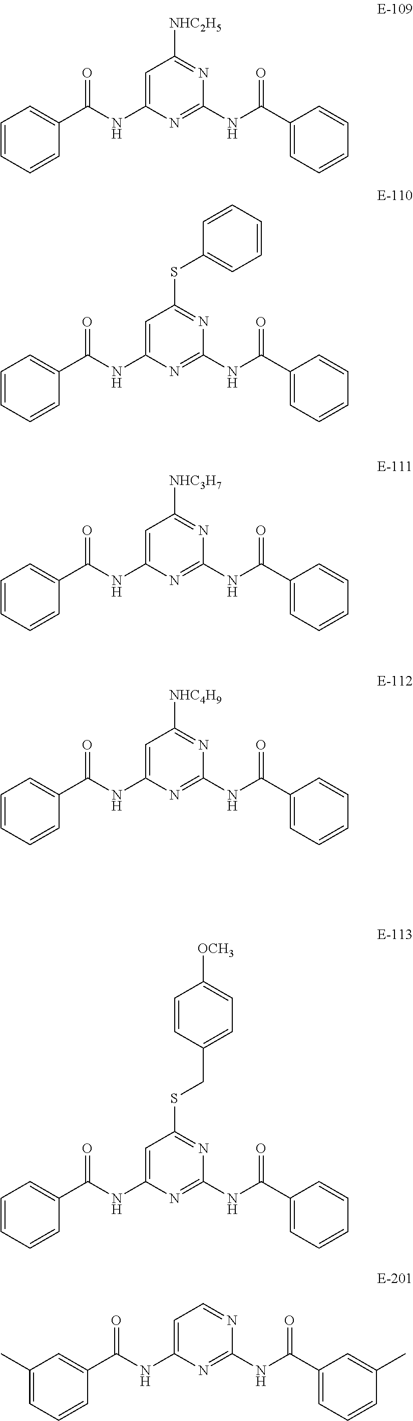

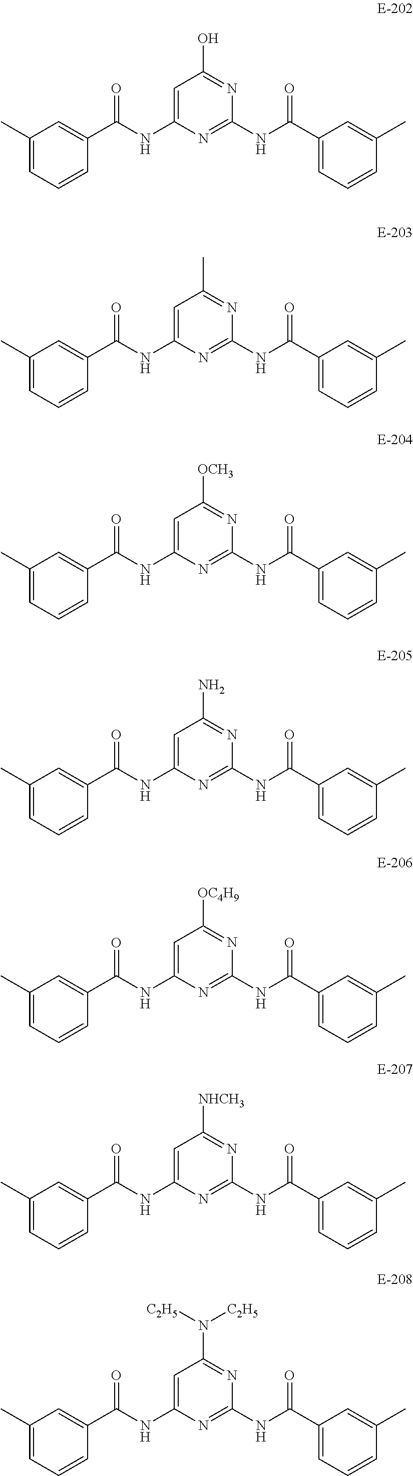

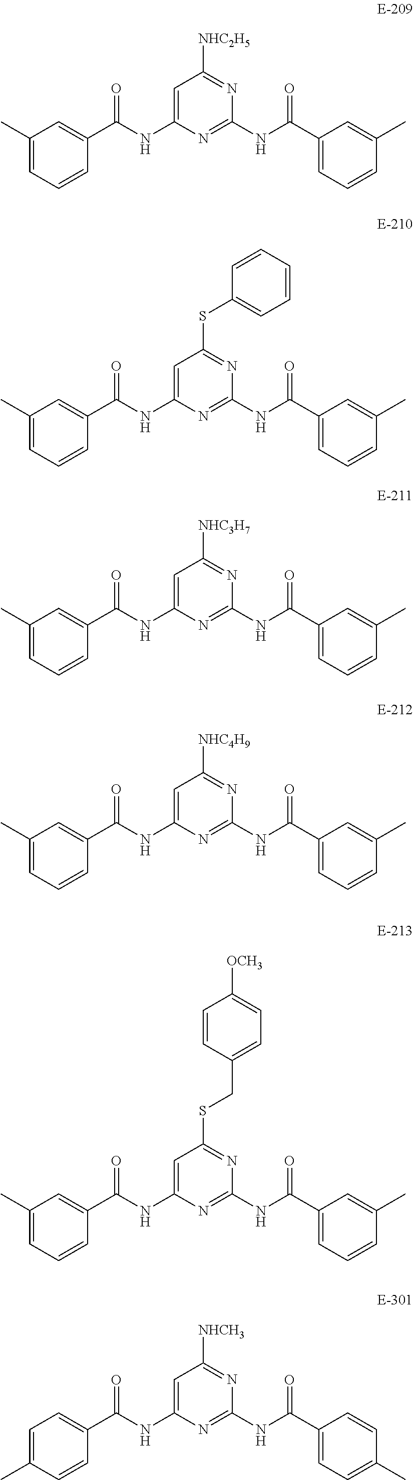

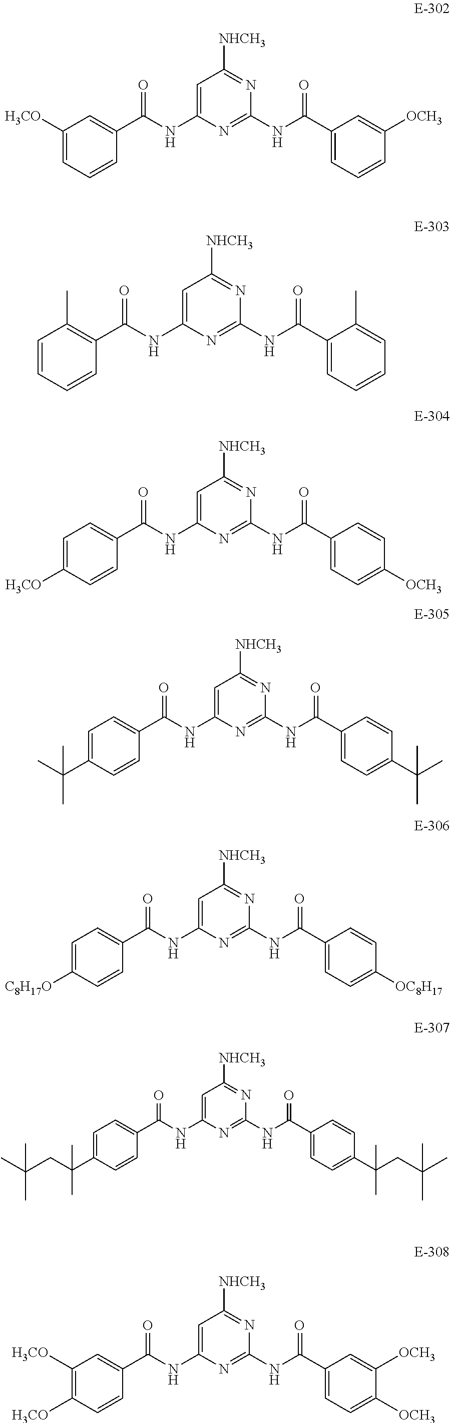

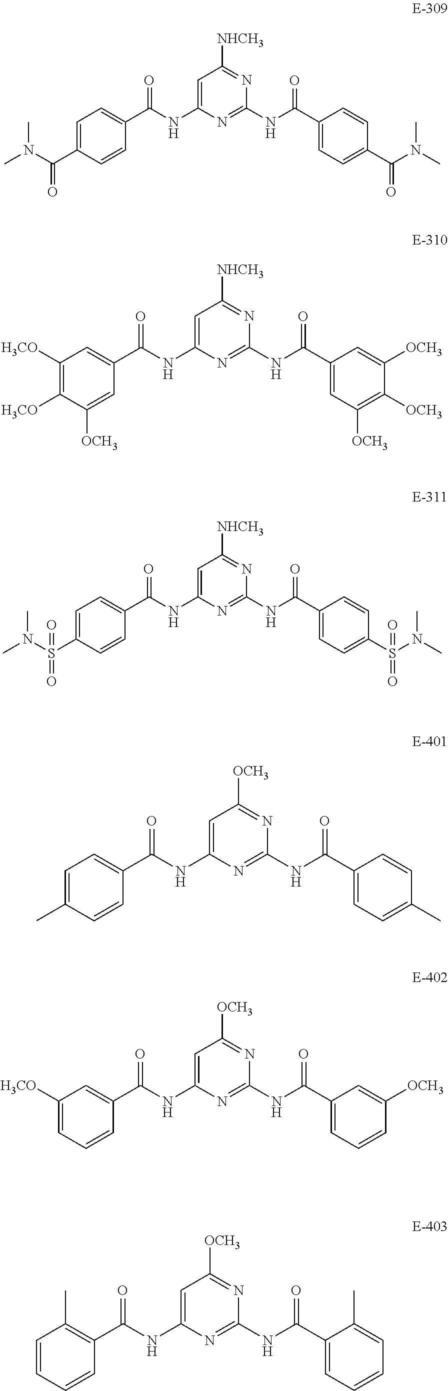

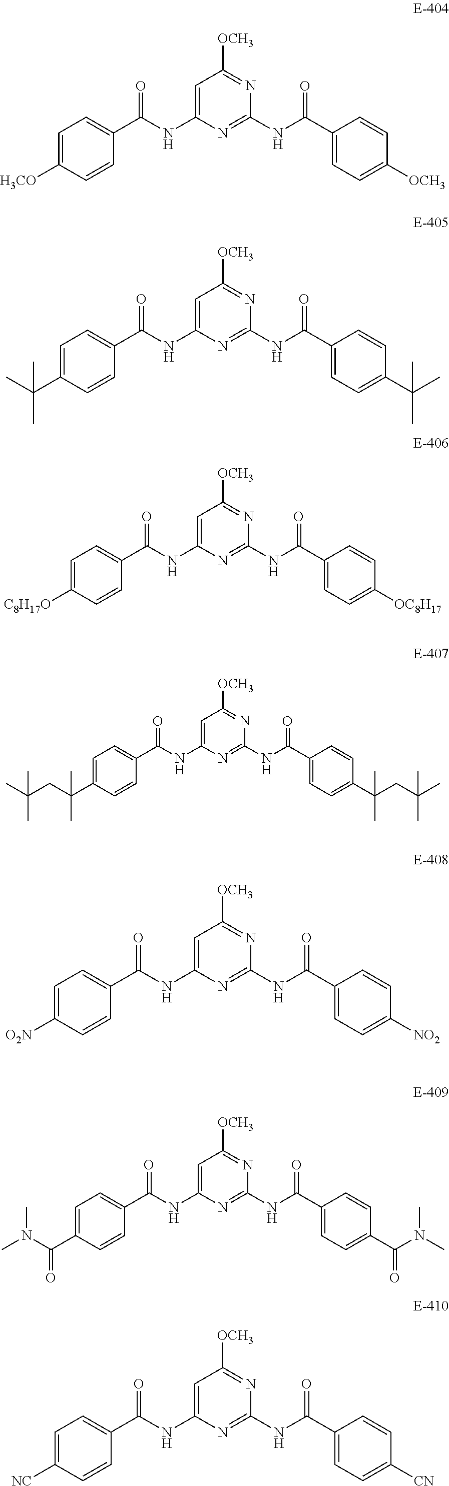

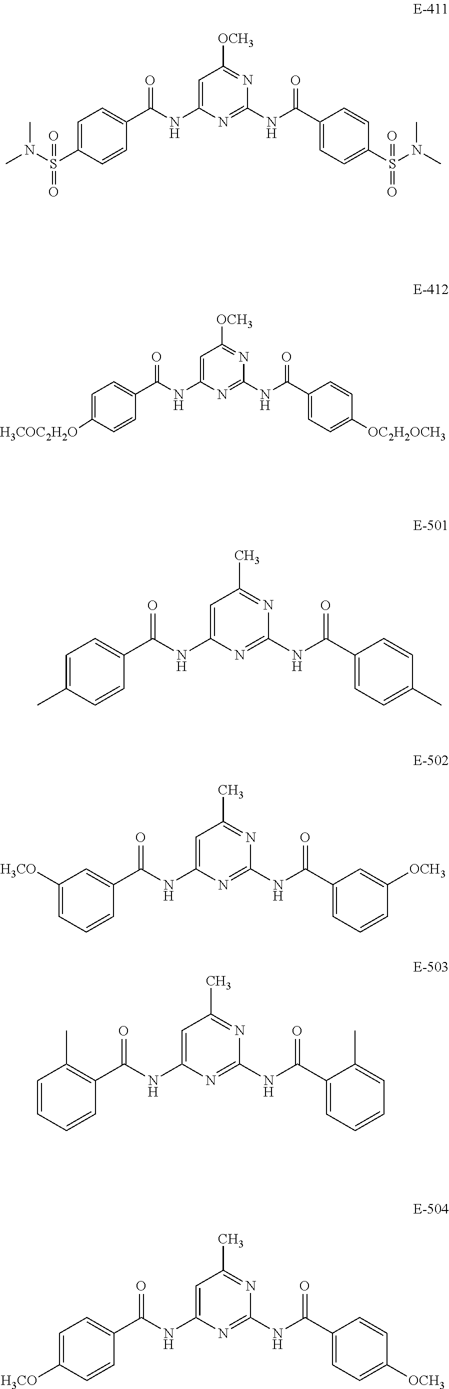

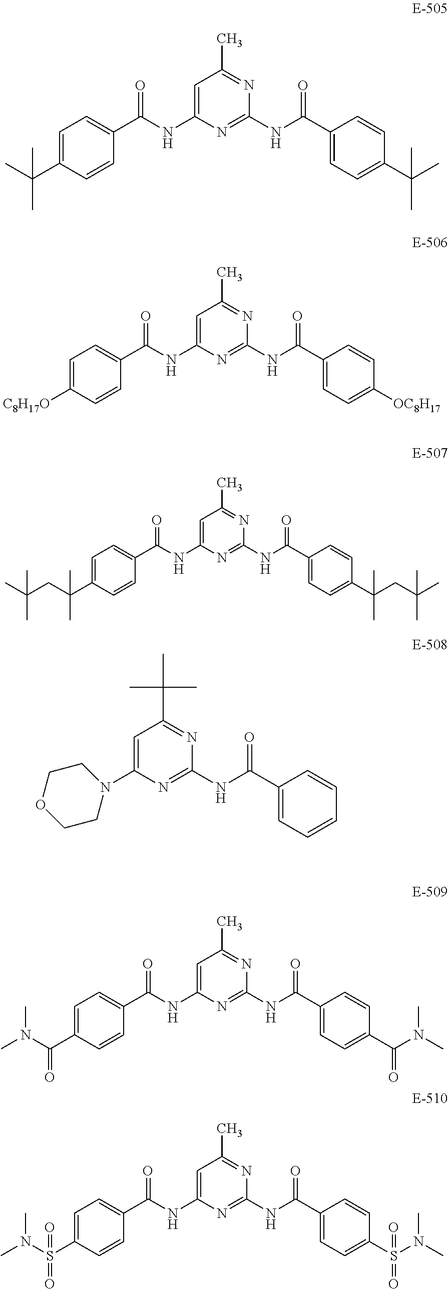

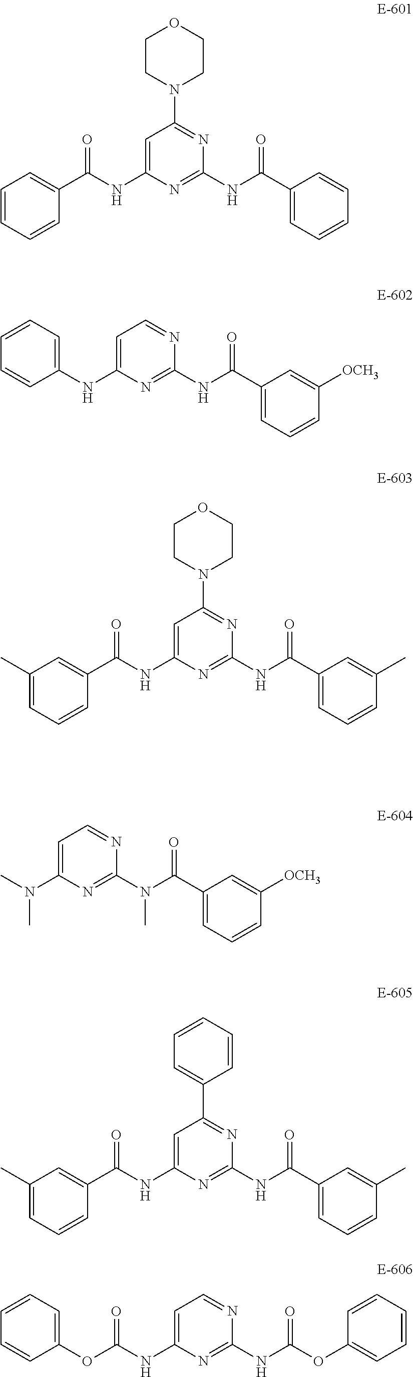

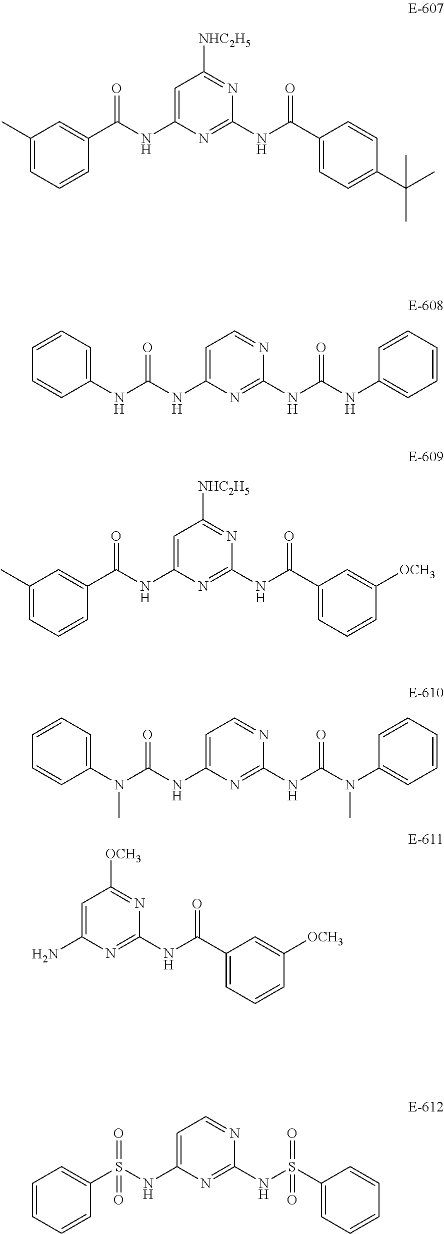

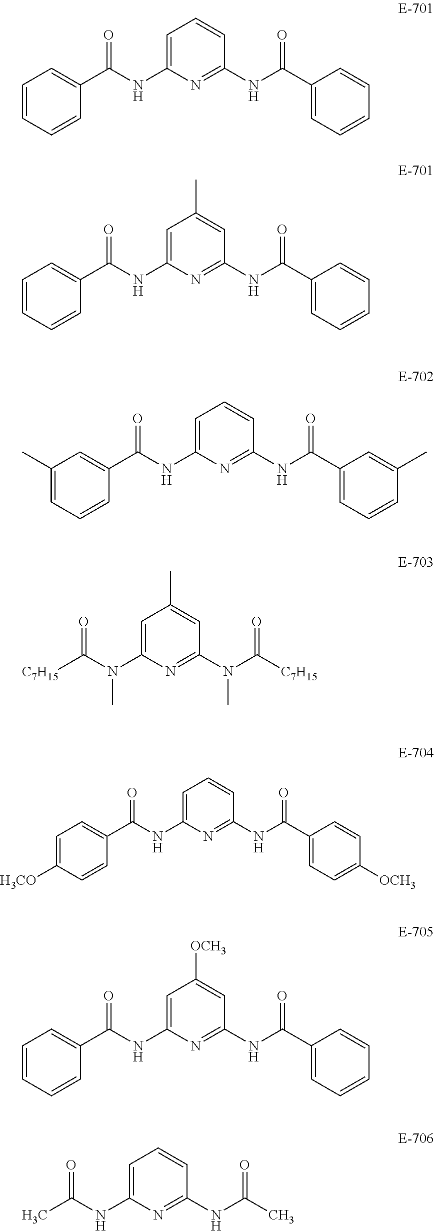

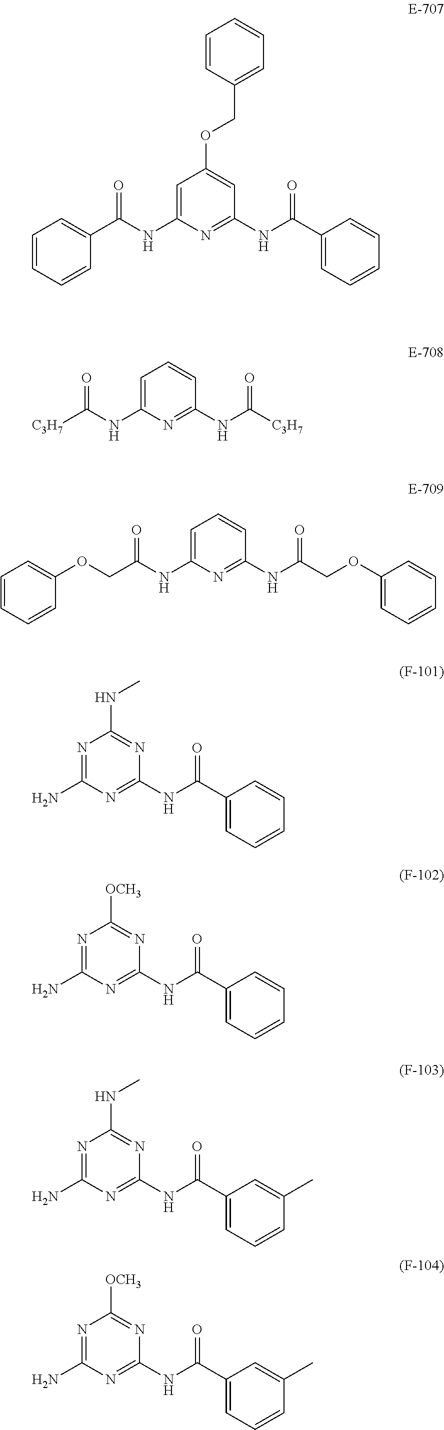

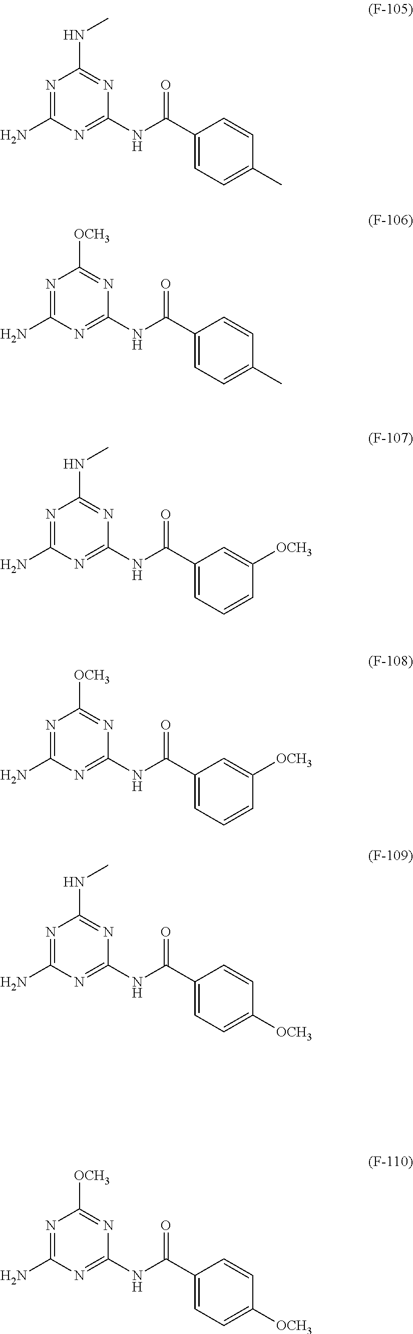

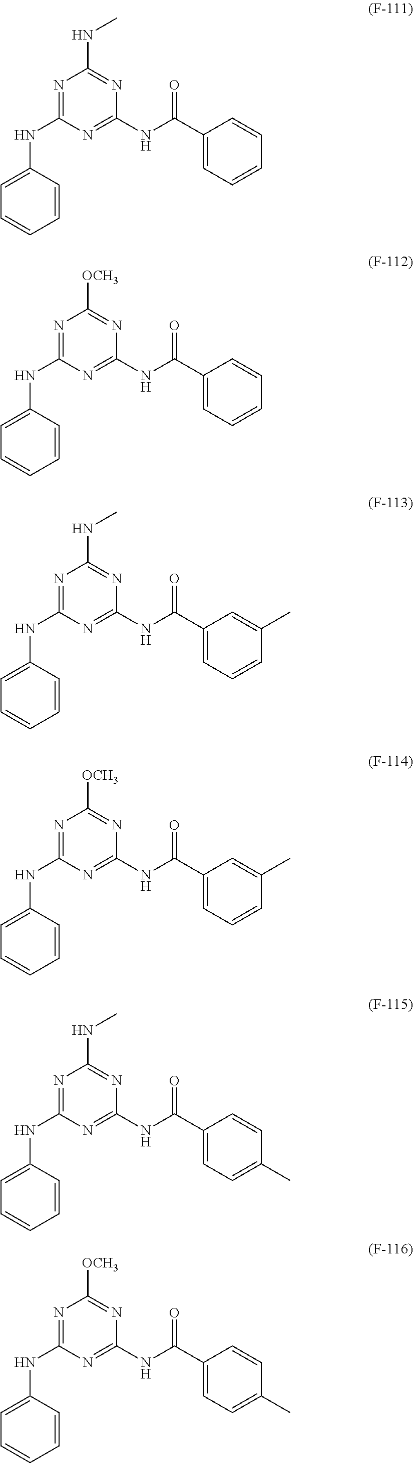

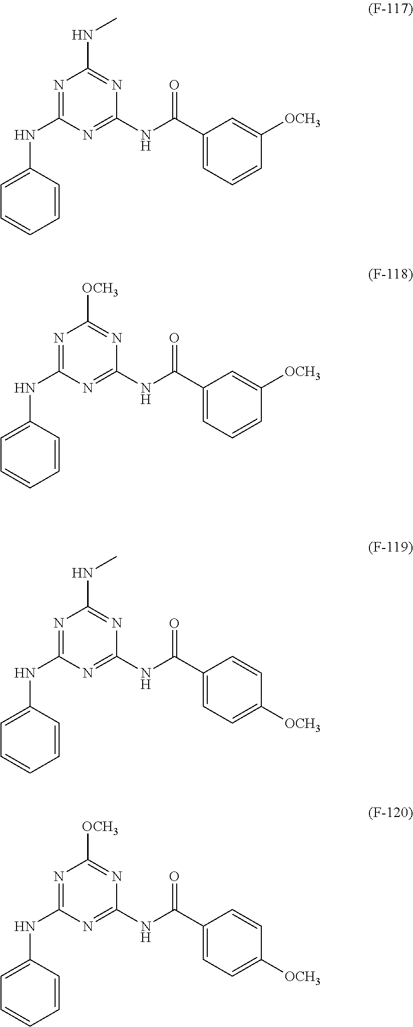

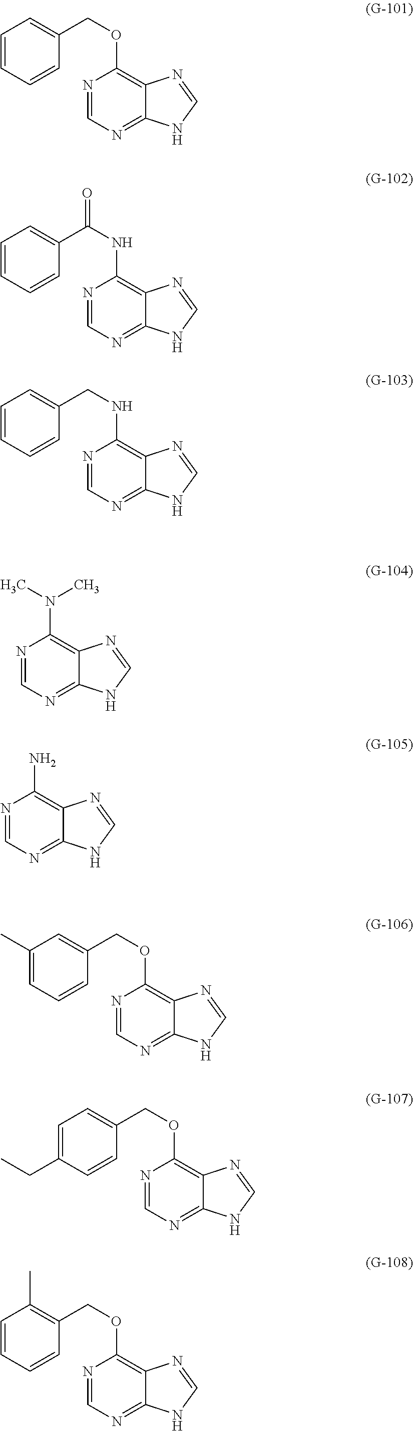

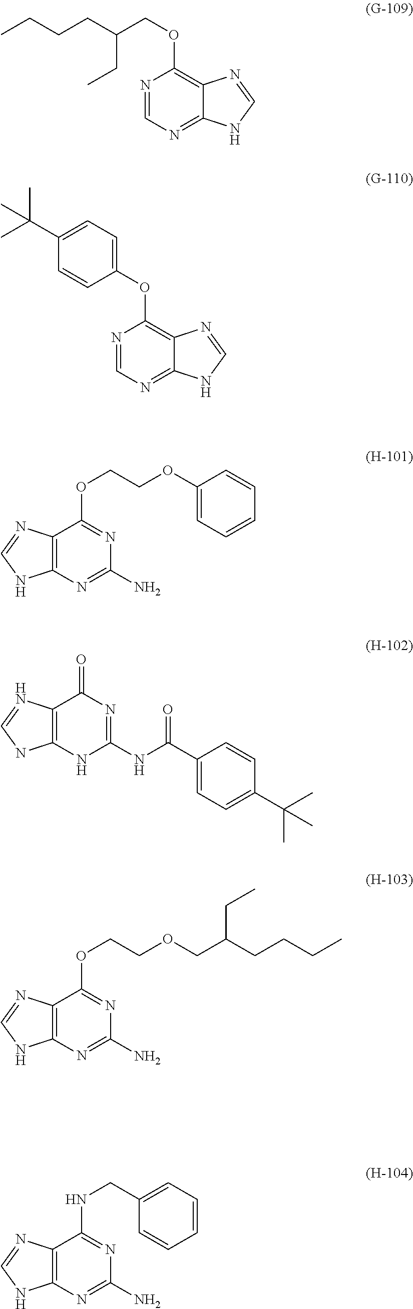

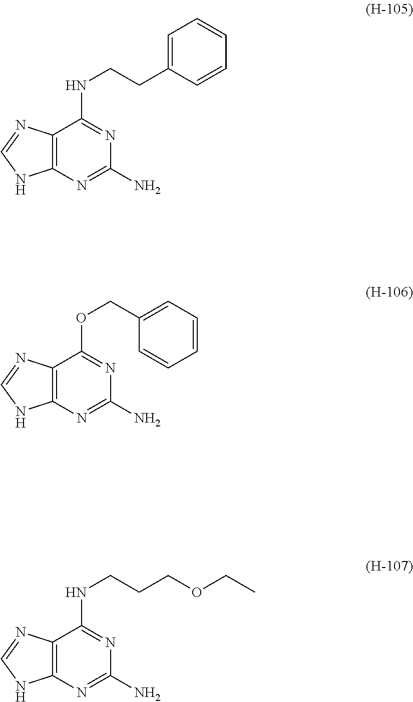

(Other Additives than Non-Phosphate Compound)

The cellulose acylate film of the invention may contain any other additive capable of being added to ordinary cellulose acylate films, than the above-mentioned non-phosphate compound.

The additive includes, for example, other plasticizer than the above-mentioned non-phosphate compound, fine particles, retardation enhancer, antioxidant, thermal degradation inhibitor, colorant, UV absorbent, etc.

As those additives, preferably used herein are the compounds described in WO2008-126535.

### (1) Fine Particles:

Examples of inorganic compounds usable as fine particles in the invention include silicon dioxide, titanium dioxide, aluminium oxide, zirconium oxide, calcium carbonate, talc, clay, calcined kaolin, calcined calcium silicate, calcium silicate hydrate, aluminium silicate, magnesium silicate and calcium phosphate.

As the fine particles, preferred are those containing silicon as reducing the haze of the film, and more preferred is silicon dioxide.

Preferably, the mean particle size of the primary particles of the fine particles is from 5 to 50 nm, more preferably from 7 to 20 nm. Preferably, the fine particles are in the film mainly as secondary aggregates thereof having a particle size of from 0.05 to 0.3 μm.

As the fine particles of silicon dioxide, for example, usable are commercial products of Aerosil R972, R972V, R974, R812, 200, 200V, 300, R202, OX50 and TT600, NAX50 (all by Nippon Aerosil).

Fine particles of zirconium oxide are sold on the market as trade names of Aerosil R976 and R811 (by Nippon Aerosil), and these can be used here.

Examples of the polymer usable here as fine particles thereof include silicone resin, fluororesin and acrylic resin. Silicone resin is preferred, and more preferred is one having a three-dimensional network structure. For example, Tospearl 103, 105, 108, 120, 145, 3120 and 240 are sold as commercial products (all by Toshiba Silicone), and these are usable herein.

Of those, Aerosil 200V and Aerosil R972V are especially preferred as more effectively lowering the friction coefficient of the cellulose derivative film with keeping the haze of the film low.

The content of the fine particles relative to the cellulose acylate in the cellulose acylate film of the invention is preferably from 0.05 to 1% by mass, more preferably from 0.1 to 0.5% by mass. In case where the film is a multilayered cellulose derivative film produced according to a co-casting method, it is desirable that the film contains the fine particles in that content especially in the surface thereof.

### (2) Retardation Enhancer:

The film of the invention may contain a retardation enhancer. Containing a retardation enhancer, the film can exhibit high retardation expressibility even though stretched at a low draw ratio. On the other hand, when the film of the invention is produced according to the production method for cellulose acylate film of the invention to be mentioned below, the film can secure good retardation expressibility even though not containing a retardation enhancer.

The type of the retardation enhancer is not specifically defined. The retardation enhancer includes rod-shaped compounds or compounds having a cyclic structure such as a cycloalkane or aromatic ring, and the above-mentioned non-phosphate compounds having the ability to enhance retardation. As the cyclic structure-having compounds, preferred are discotic compounds. As the rod-shaped or discotic compounds, compounds having at least two aromatic rings are preferred as the retardation enhancer for use herein.

Two or more different types of retardation enhancers may be used here as combined.

Preferably, the retardation enhancer has a maximum absorption in a wavelength region of from 250 to 400 nm, more preferably substantially not having an absorption in a visible region.

As the retardation enhancer, for example, usable are the compounds described in JP-A 2004-50516 and 2007-86748 and the compounds described in JP-A 2010-46834, to which, however, the invention is not limited.

As the discotic compound for use herein, for example, preferred are the compounds described in EP 0911656-A2, the triazine compounds described in JP-A 2003-344655, and the triphenylene compounds described in JP-A 2008-150592, [0097] to [0108].

The discotic compounds usable herein may be produced according to known methods, for example, according to the method described in JP-A 2003-344655, the method described in JP-A 2005-134884, etc.

In addition to the above-mentioned discotic compounds, also preferred for use herein are rod-shaped compounds having a linear molecular structure; and for example, the rod-shaped compounds described in JP-A 2008-150592, [0110] to [0127] are preferred.

### (3) Antioxidant, Thermal Degradation Inhibitor:

As an antioxidant and a thermal degradation inhibitor, any known ones are usable in the invention. In particular, preferred are lactone compounds, sulfur compounds, phenolic compounds, double bond-having compounds, hindered amines, phosphorus compounds. As the antioxidant and the thermal degradation inhibitor for use herein, preferred are the compounds described in WO2008-126535.

### (4) Colorant:

The film of the invention may contain a colorant. Colorant generally includes dye and pigment; but in the invention, the colorant is meant to indicate a substance having an effect of making a liquid crystal panel have a bluish tone, or an effect of controlling the yellow index of the panel or reducing the haze thereof. As the colorant, preferred for use herein are the compounds described in WO2008-126535.

### <Properties of Cellulose Acylate Film>

### (Re, Rth)

Of the film of the invention, the in-plane retardation and the thickness-direction retardation at a wavelength of 550 nm satisfy the following formulae (1) and (2):

40 nm≦Re(550)≦60 nm (1)

wherein Re(550) means the in-plane retardation of the film at a wavelength of 550 nm,

100 nm≦Rth(550)≦300 nm (2)

wherein Rth(550) means the thickness-direction retardation of the film at a wavelength of 550 nm.

Preferably, the film of the invention expresses the retardation within the above range, from the viewpoint of improving the contrast of liquid crystal display devices and of reducing the color shift thereof at the time of black level of display.

Preferably, Re(550) is from 45 to 60 nm, more preferably from 48 to 60 nm.

Preferably, Rth(550) is from 105 to 280 nm, more preferably from 110 to 250 nm.

Preferably, the film of the invention satisfies the following formula (6), from the viewpoint of satisfying both thickness reduction and sufficient Rth expression of the film and of reducing the material cost of the film.

3.0×10⁻³<Rth(550)/d (6)

wherein Rth(550) means the thickness-direction retardation (unit: nm) of the film at a wavelength of 550 nm, and d means the thickness (unit: mm) of the film.

More preferably, Rth(550)/d is from 3.0 to 10.0×10⁻³, even more preferably from 3.4 to 9.0×10⁻³.

Preferably, the film of the invention is a biaxial optical compensatory film.

The biaxial optical compensatory film means that nx, ny and nz of the optical compensatory film all differ from each other, in which nx means the refractive index in the in-plane slow axis direction, ny means the in-plane refractive index in the direction perpendicular to nx, and nz means the refractive index in the direction perpendicular to nx and ny. More preferably in the invention, nx>ny>nz.

The film of the invention having the biaxial optical property is preferred in that, when it is incorporated in a liquid crystal display device, especially in a VA-mode liquid crystal display device and when the device is watched in an oblique direction, the problem of color shift can be reduced.

In this description, Re(λ) and Rth(λ) each mean the in-plane retardation and the thickness-direction retardation, respectively, of a film at a wavelength of λ. Unless otherwise specifically indicated in this description, the wavelength λ is 550 nm. Re(λ) is measured by applying a light having a wavelength of λ nm to a film sample in the normal direction of the film, using KOBRA 21ADH (by Oji Scientific Instruments). Rth(λ) is determined as follows: With the in-plane slow axis (determined by KOBRA 21ADH) taken as the tilt axis (rotation axis) of the film (in case where the film has no slow axis, the rotation axis of the film may be in any in-plane direction of the film), Re(λ) of the film is measured at 6 points in all thereof, from the normal direction of the film up to 50 degrees on one side relative to the normal direction thereof at intervals of 10°, by applying a light having a wavelength of λ nm from the tilted direction of the film. Based on the thus-determined retardation data of Re(λ), the assumptive mean refractive index and the inputted film thickness, Rth(λ) of the film is computed with KOBRA 21ADH. Apart from this, Re(λ) may also be measured as follows: With the slow axis taken as the tilt axis (rotation axis) of the film (in case where the film has no slow axis, the rotation axis of the film may be in any in-plane direction of the film), the retardation is measured in any desired two directions, and based on the thus-determined retardation data, the assumptive mean refractive index and the inputted film thickness, Rth is computed according to the following formulae (A) and (B). In this, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below. Cellulose acylate (1.48), cycloolefin polymer (1.52), polycarbonate (1.59), polymethyl methacrylate (1.49), polystyrene (1.59). With the assumptive mean refractive index and the film thickness inputted thereinto, KOBRA 21ADH can compute nx, ny and nz. From the thus-computed data nx, ny and nz, Nz=(nx−nz)/(nx−ny) is induced.

### (A)

$$Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}}$$

In this, Re(θ) means the retardation of the film in the direction tilted by an angle θ from the normal direction to the film; nx, ny and nz each mean the refractive index in each main axis direction of an index ellipsoid; and d means the thickness of the film.

Rth=((nx+ny)/2−nz)×d (B)

In this, the mean refractive index n is needed as the parameter, for which used are the data measured with an Abbe's refractiometer (Atago's “Abbe Refractiometer 2-T”).

### (Film Thickness)

The film of the invention is characterized in that its thickness is from 10 μm to 45 μm in order to provide a thinner and lighter display for the demand for slate PC, etc. Preferably, the thickness of the film of the invention is from 15 to 30 μm, more preferably from 18 to 28 μm. In case where the film of the invention is a laminate film, preferably, the total thickness of the film falls within the above-mentioned preferred range.

### (Dimensional Change)

The absolute value of the dimensional change of the invention preferably satisfies the following formula (3):

|{(L′−L0)/L0}×100(%)|≦0.5% (3)

wherein L0 means the length (unit: mm) of the film before aged for 24 hours at 60° C. and at a relative humidity of 90%; and L′ means the length (unit: mm) of the film after aged for 24 hours at 60° C. and at a relative humidity of 90% and further after conditioned for 2 hours.

Preferably, the absolute value of the dimensional change of the film of the invention in the machine direction and in the direction perpendicular to the machine direction satisfies the above-mentioned formula (3).

Preferably, the absolute value of the dimensional change of the film of the invention before and after aged for 24 hours at 60° C. and at a relative humidity of 90% is at most 0.3% in the machine direction, more preferably at most 0.2%, even more preferably at most 0.1%.

Preferably, the absolute value of the dimensional change of the film of the invention before and after aged for 24 hours at 60° C. and at a relative humidity of 90% is at most 0.4% in the direction perpendicular to the machine direction, more preferably at most 0.3%, even more preferably at most 0.2%.

### (Internal Haze)

Preferably, the cellulose acylate film of the invention has an internal haze of at most 0.1%.

The haze means the haze value (%) measured according to JIS K7136.

The internal haze of the film of the invention is determined as follows: A few drops of glycerin are applied onto both surfaces of the cellulose acylate film to be analyzed, the film is sandwiched between two glass plates (MICRO SLIDE GLASS Lot No. S9213, by Matsunami) each having a thickness of 1.3 mm, and the haze value (%) of the sample is measured. On the other hand, a few drops of glycerin are put between two glass plates, and the haze value (%) thereof is measured. The latter value is subtracted from the former value to give the internal haze value (%) of the film sample.

The haze of the cellulose acylate film is measured with a haze meter (NDH2000, by Nippon Denshoku Kogyo). Briefly, a film sample to be analyzed is left in an environment at 23° C. and a relative humidity of 55% for 24 hours, and its haze is measured in the same environment.

Preferably, the internal haze of the cellulose acylate film of the invention is at most 0.1%, more preferably at most 0.05%, even more preferably at most 0.02%.

In general, it is said that the haze of film is preferably smaller. However, merely low total haze of film is insufficient for increasing the front contrast of a display device, and the present inventors have controlled the internal haze of the film to fall within the above range and have succeeded in increasing the front contrast of liquid crystal display devices.

### (Layer Configuration of Cellulose Acylate Film)

The film of the invention may be a single-layer film or may have a laminate structure of two or more layers, but is preferably a single-layer film.

### (Film Width)

Preferably, the film width of the invention is at least 1000 mm, more preferably at least 1500 mm, even more preferably at least 1800 mm.

### [Production Method for Cellulose Acylate Film]

The production method for the cellulose acylate film of the invention (hereinafter this may be referred to as the production method for cellulose acylate film) is not specifically defined.

The production method for cellulose acylate film is for producing the cellulose acylate-containing film mentioned above according to a solution casting method or a melt casting method. From the viewpoint of bettering the film surface condition, the production method preferably comprises a step of forming the cellulose acylate-containing film in a mode of solution casting film formation.

The production method for cellulose acylate film is described below with reference to an embodiment of solution casting film formation; however, the invention is not limited to the mode of solution casting film formation. In case where the cellulose acylate film of the invention is produced according to a melt casting method, any known method is employable.

### <Polymer Solution>

In the solution casting film formation method, a polymer solution containing cellulose acylate and optionally various additives (cellulose acylate solution) is formed into a web. The polymer solution for use in the solution casting film formation method (hereinafter this may be referred to as cellulose acylate solution or dope) is described below.

### (Solvent)

The cellulose acylate for use in the invention is dissolved in a solvent to form a dope, which is cast on a substrate to form a film thereon. In this step, the solvent must be evaporated away after extrusion or casting, and therefore, a volatile solvent is preferably used.

Further, the solvent is one not reacting with a reactive metal compound, a catalyst or the like and not dissolving the casting substrate. Two or more different types of solvents may be used here as combined.

As the case may be, a cellulose acylate and a hydrolyzable and polycondensable reactive metal compound may be dissolved in different solvents, and the resulting solutions may be mixed later.

An organic solvent capable of well dissolving the cellulose acylate is referred to as a good solvent, and an organic solvent exhibiting the main effect for the dissolution and used in a major amount is referred to as a main (organic) solvent.

Examples of the good solvent include ketones such as acetone, methyl ethyl ketone, cyclopentanone, cyclohexanone, etc.; ethers such as tetrahydrofuran (THF), 1,4-dioxane, 1,3-dioxolan, 1,2-dimethoxyethane, etc.; esters such as methyl formate, ethyl formate, methyl acetate, ethyl acetate, amyl acetate, γ-butyrolactone, etc.; as well as methyl cellosolve, dimethylimidazolinone, dimethylformamide, dimethylacetamide, acetonitrile, dimethyl sulfoxide, sulforane, nitroethane, methylene chloride, methyl acetacetate, etc. Preferred are 1,3-dioxolan, THF, methyl ethyl ketone, acetone, methyl acetate and methylene chloride.

Preferably, the dope contains from 1 to 40% by mass of an alcohol having from 1 to 4 carbon atoms, in addition to the above-mentioned organic solvent.

The alcohol serves as a gelling solvent in such a manner that, after the dope has been cast on a metal support, the solvent begins to evaporate and the proportion of the alcohol in the dope increases whereby the web (the dope film formed by casting the cellulose acylate dope on a support may be referred to as web) may be readily gelled and may be well peeled from the metal support. In case where the proportion of the alcohol is small, it may play a role in promoting the dissolution of cellulose acylate in a chlorine-free organic solvent, or may play a role in retarding the gellation and precipitation of reactive metal compound and retarding the viscosity increase of the dope.

The alcohol having from 1 to 4 carbon atoms includes methanol, ethanol, n-propanol, iso-propanol, n-butanol, sec-butanol, tert-butanol, propylene glycol monomethyl ether, etc.

Of those, preferred is ethanol as having the advantages of excellent stability in dope, relatively low boiling point, good dryability and nontoxicity. These organic solvents do not have the ability to dissolve cellulose acylate by themselves and are therefore poor solvents.

The cellulose acylate to constitute the cellulose acylate film of the invention contains a hydroxyl group or a hydrogen-bonding functional group of esters, ketones or the like, and therefore it is desirable that the solvent contains an alcohol in an amount of from 5 to 30% by mass of the whole solvent, more preferably from 7 to 25% by mass, even more preferably from 10 to 20% by mass, from the viewpoint of reducing the film peeling load from the casting support.

Controlling the alcohol content could facilitate the expressibility of Re and Rth of the cellulose acylate film produced according to the production method of cellulose acylate film mentioned above. Concretely, when the alcohol content is increased, then the drying temperature (heat treatment temperature) before stretching in the production method for cellulose acylate film mentioned above could be set relatively low, whereby the ultimate range of Re and Rth could be enlarged more.

In the invention, it is also effective to make the film contain a small amount of water for controlling the dope viscosity, for increasing the wet film strength in drying and for increasing the dope strength in drum casting. For example, water may be in the dope in an amount of from 0.1 to 5% by mass of the whole dope, preferably from 0.1 to 3% by mass, more preferably from 0.2 to 2% by mass.

Examples of the combination of organic solvents preferred for use as the solvent for the polymer solution in the invention are described in JP-A 2009-262551.

If desired, a non-halogen organic solvent may be used as the main solvent, and its details are described in Hatsurriei Kyokai Disclosure Bulletin (No. 2001-1745, published by the Hatsumei Kyokai on Mar. 15, 2001).

The cellulose acylate concentration in the polymer solution in the invention is preferably from 5 to 40% by mass, more preferably from 10 to 30% by mass, most preferably from 15 to 30% by mass.

The cellulose acylate concentration can be so controlled that it could reach a predetermined level in the stage of dissolving cellulose acylate in a solvent. If desired, a solution having a low concentration (for example, having a concentration of from 4 to 14% by mass) is previously prepared, and it may be concentrated by evaporating the solvent. Also if desired, a high-concentration solution is previously prepared and it may be diluted. Adding an additive may lower the cellulose acylate concentration.

The time for additive addition may be suitably determined depending on the type of the additive.

The solvent that is most preferred for dissolving the polymer compound, cellulose acylate in a high concentration with satisfying the above condition is a mixed solvent of methylene chloride/ethyl alcohol of from 95/5 to 80/20. Also preferred is a mixed solvent of methyl acetate/ethyl alcohol of from 60/40 to 95/5.

### <Details of Processing Steps>

### (1) Dissolution Step:

This is a step of dissolving a cellulose acylate in an organic solvent comprising mainly a good solvent for the cellulose acylate in a dissolver with stirring therein, to thereby form a dope, or a step of mixing an additive solution in a cellulose acylate solution to form a dope.

For dissolution of cellulose acylate, employable are various dissolution methods such as a method to be attained under normal pressure, a method to be attained at a temperature not higher than the boiling point of the main solvent, a method to be attained under pressure at a temperature not lower than the boiling point of the main solvent, a method of cooling dissolution as in JP-A 9-95544, 9-95557 or 9-95538, a method to be attained under high pressure as in JP-A 11-21379, etc. Especially preferred is the method to be attained under pressure at a temperature not lower than the boiling point of the main solvent.

Preferably, the cellulose acylate concentration in the dope is from 10 to 35% by mass. An additive is added to the dope during or after dissolution and is again dissolved and dispersed therein, then the resulting dope is filtered through a filtering material and defoamed, and thereafter fed to the next step with a feeding pump.

### (2) Casting Step:

This is a step of feeding the dope to a pressure die via a feeding pump (for example, pressure metering pump), and casting the dope to the casting position of an endlessly running endless metal belt, for example, a stainless belt, or of a rotating metal support such as a metal drum or the like, through a pressure die slit.

Preferred is a pressure die of which the slit form of the nozzle can be regulated to facilitate uniform film thickness. The pressure die includes a coathanger die, a T-die and the like, any of which is favorably usable here. The surface of the metal support is mirror-finished. For increasing the film formation speed, two or more pressure dies may be provided for a metal support and the dope may be divided for multilayer formation. Multiple dopes may be simultaneously case according to a co-casting method to produce a laminate-structured film, and the mode is also preferred here.

### (3) Solvent Evaporation Step:

This is a step of heating the web (the precursor that is prior to a finished cellulose acylate film and contains much solvent is referred to as web) on the metal support so as to remove the solvent from the web to such a degree that the web can be released from the metal support.

For solvent evaporation, there may be employed a method of applying an air blow to the side of the web and/or a method of heating the back of the metal support with a heating liquid, a method of heating both the surface and the back of the web by radiation heat, etc. Preferred is the method of heating the back with a heating liquid, as securing good drying efficiency. Also preferred is combination of these methods. In the method of heating the back with a heating liquid, preferably, the back of the support is heated at a temperature not higher than the boiling point of the main solvent of the organic solvent used in the dope or of the organic solvent having the lowest boiling point.

### (4) Peeling Step:

This is a step of peeling the web from which the solvent has been evaporated away on the metal support, at the peeling position. The peeled web is then fed to the next step. When the residual solvent amount (represented by the formula mentioned below) in the web to be peeled is too large, then the web may be difficult to peel, or on the contrary, when the web is too much dried on the metal support and then peeled, then a part of the web may be broken or cut along the way.

In this, as a method of increasing the film formation speed (in which the film formation speed may be increased by peeling the web at a time when the residual solvent amount is as large as possible), there may be mentioned a gel casting method. For example, there are a method of adding a poor solvent for cellulose acylate to the dope, then casting the dope and gelling it; and a method of gelling the dope with lowering the temperature of the metal support. The dope may be gelled on the metal support to thereby increase the strength of the film to be peeled, thereby increasing the film formation speed.

Preferably, the residual solvent amount in the web on the metal support in peeling the web is controlled to fall within a range of from 5 to 150% by mass, depending on the condition of the drying load intensity, the length of the metal support, etc. However, in case where the web is peeled at a time when the residual solvent amount therein is larger, the residual solvent amount in peeling will be determined in consideration of both the economical film formation speed and the film quality. In the invention, the temperature of the peeling position on the metal support is preferably from −50 to 40° C., more preferably from 10 to 40° C., most preferably from 15 to 30° C.

Preferably, the residual solvent amount in the web at the peeling position is from 10 to 150% by mass, more preferably from 10 to 120% by mass.

The residual solvent amount may be expressed by the following formula:

Residual Solvent Amount(% by mass)={(M−N)/N}×100

wherein M is the mass of the web at any point, and N is the mass of the web having the mass of M after dried at 110° C. for 3 hours.

### (5) Drying or Heat Treatment Step, Stretching Step:

In the production method for cellulose acylate film, preferably, the film is stretched at a temperature of from 130 to 185° C. in the stretching step, from the viewpoint of increasing the optical expressibility relative to the thickness of the cellulose acylate film to be obtained, or that is, increasing Rth(550)/d of the film.

After the peeling step, preferably, the web is dried in a drying unit where the web is led to alternately pass through multiple rolls disposed therein and/or in a tenter unit where the web is clipped at both sides thereof and conveyed therethrough.

In the production method for cellulose acylate film, the web may be or may not be heat-treated before stretched.

Preferably, the heat treatment time is at most 30 minutes, more preferably at most 20 minutes, even more preferably at most 10 minutes or so.

For drying and heat treatment, in general, a hot air blow is applied to both surfaces of the web; but in place of air, a microwave may be applied thereto for heating. The temperature, the air blow amount and the time may vary depending on the solvent to be used; and suitable conditions may be selected in accordance with the type and the combination of the solvents to be used.

In the production method for cellulose acylate film, the film may be stretched in any direction of the machine direction (hereinafter this may be referred to as longitudinal direction) or in the direction perpendicular to the machine direction (hereinafter this may be referred to as lateral direction), but is preferably stretched in the lateral direction from the viewpoint of making the film express the desired retardation. More preferably, the film is stretched biaxially both in the machine direction and in the lateral direction. The stretching may be attained in one stage or in multiple stages.

Preferably, the draw ratio in stretching the film in the machine direction is from 0 to 20%, more preferably from 0 to 15%, even more preferably from 0 to 10%. The draw ratio (elongation) in stretching the cellulose acylate web may be attained by the peripheral speed difference between the metal support speed and the peeling speed (peel roll draw). For example, in case where an apparatus having two nip rolls is used, the rotation speed of the nip roll on the outlet side is made faster than that of the nip roll on the inlet side, whereby the cellulose acylate film may be stretched preferably in the machine direction (longitudinal direction). The stretching may control the retardation expressibility of the film.

“Draw ratio (%)” as referred to herein is computed according to the following formula:

Draw Ratio(%)=100×{(length after stretching)−(length before stretching)}/(length before stretching).

The draw ratio in stretching the film in the direction perpendicular to the machine direction is preferably from more than 15% to less than 35%, more preferably from 16 to 34%, even more preferably from 17 to 33%.

In the method of stretching the film in the direction perpendicular to the machine direction in the invention, preferably used is a tenter apparatus.

In biaxially stretching the film, for example, the film may be relaxed by from 0.8 to 1.0 time in the machine direction to thereby make the film have the desired retardation. The draw ratio in stretching may be defined depending on the intended optical properties of the film. In producing the cellulose acylate film of the invention, the film may be monoaxially stretched in the machine direction.

In the production method for cellulose acylate film, the film is stretched preferably at a temperature of from 130 to 185° C. in the stretching step. Also preferably, the stretching temperature may be not higher than Tg−5° C. The stretching within the range is hereinafter referred to as low-temperature stretching. Low-temperature stretching of the formed film is favorable as increasing the Rth expressibility of the film of the invention without increasing the film thickness, or that is, as increasing more Rth(550)/d of the film. Not adhering to any theory, the polymer and the additive in the film would be more hardly oriented during the low-temperature stretching than during high-temperature stretching, and therefore the film could express Re not lowering Rth thereof through the low-temperature stretching.

On the other hand, in case where an ordinary known cellulose acylate film is stretched in a mode of low-temperature stretching, its harmful results are that the dimensional change of the film in wet heat environments may increase and the haze of the film may also increase. Not adhering to any theory, the harmful results would be caused because residual strain readily remains in film after the low-temperature stretching and some crazes are readily formed in the film during the low-temperature stretching.

As opposed to this, in the production method for cellulose acylate film of the invention described here, the film is, after the stretching step, processed in the wet heat treatment step under the specific condition to be mentioned below, in which, therefore, the residual strain generated through the low-temperature stretching can be released; and therefore in the method including the low-temperature stretching step, the effect of the invention can be well secured and the film produced can enjoy the effect of enhancing the Rth expressibility through the low-temperature stretching treatment.

In a more preferred embodiment of the production method for cellulose acylate film, a film of cellulose acetate having a low degree of acetyl substitution (especially cellulose acetate having a degree of acetyl substitution of from 2.0 to 2.3) is stretched in a mode of low-temperature stretching, whereby the film can be prevented from having a haze caused by the low-temperature stretching treatment. Not adhering to any theory, when a cellulose acetate having a low degree of acetyl substitution is used as the cellulose acylate in the invention, the cellulose acetate having a low degree of acetyl substitution has high compatibility with the above-mentioned sugar ester compound, and therefore it is expected that the two may disperse uniformly with no phase separation of the additives during low-temperature stretching. Accordingly, the stretching stress may be so controlled as to be uniformly given to the whole web, and the stretched film can be prevented from having crazes to be often formed during low-temperature stretching. As a result, the internal haze of the film produced according to the production method for cellulose acylate of the invention mentioned above can be controlled to fall within the above-mentioned preferred range.

Preferably, the stretching temperature is from 130 to 195° C., more preferably from 135° C. to 190° C., even more preferably from 135° C. to 185° C., further more preferably from 140° C. to 185° C.

If desired, the film may be dried after the stretching step and before the wet heat treatment step to be mentioned below. In case where the film is dried after the stretching step and before the wet heat treatment step to be mentioned below, the drying temperature, the drying air blow amount and the drying time may vary depending on the solvent to be used, and may be suitably selected in accordance with the type and the combination of the solvents to be used. In the invention, preferably, the drying temperature after the stretching step and before the wet heat treatment step to be mentioned below is lower than the stretching temperature in the stretching step, from the viewpoint of increasing the panel front contrast when the film is incorporated in a liquid crystal display device.

### (6) Wet Heat Treatment Step:

Preferably, the production method for cellulose acylate film includes a step of processing the film for wet heat treatment at a wet heat treatment temperature of from 80 to 120° C. and at an absolute humidity of from 150 to 250 g/m³.

Not adhering to any theory, when a film having a large dimensional change is incorporated in a liquid crystal display device, the problem to occur is caused by the irreversible change in the film dimension to occur when the device is kept in a condition at 60° C. and at a relative humidity of 90% for a long period of time. To solve the problem, the production method of the invention includes wet heat treatment of the film under the condition mentioned above to thereby positively generate irreversible change in the film being produced. As a result, when the cellulose acylate film produced according to the production method of the invention is mounted on a liquid crystal display device, it may prevent the generation of corner unevenness (display unevenness to occur in wet heat treatment) in oblique directions to the liquid crystal display panel.

In a more preferred embodiment of the production method for cellulose acylate film of the invention mentioned above, a cellulose acetate having a low degree of acetyl substitution (especially a cellulose acetate having a degree of acetyl substitution of from 2.0 to 2.3) is used to enhance the optical expressibility of the film and the reversed wavelength dispersion characteristics expressibility thereof. The cellulose acetate having such a low degree of acetyl substitution is more advantageous from the viewpoint of the optical expressibility and the reversed wavelength dispersion characteristics expressibility, than a cellulose acetate propionate having the same degree of acyl substitution (hereinafter referred to as CAP) or than a cellulose acylate having any other acyl substituent than acetyl group and having the same degree of acyl substitution (for example, cellulose acetate phthalate described in JP-A 2009-1696). However, the film of the invention is processed for wet heat treatment under the specific condition as above, and therefore the dimensional change thereof can be fully reduced. As a result, in case where the cellulose acylate film obtained in the more preferred embodiment of the production method for cellulose acylate film of the invention mentioned above is mounted on a liquid crystal display device, the display contrast of the device can be further enhanced, the color shift on the display panel can be reduced, and the generation of corner unevenness in oblique directions to the display panel (display unevenness to occur in wet heat treatment) can be sufficiently prevented.

Especially preferably, the wet heat treatment temperature is from 90 to 110° C. The wet heat treatment temperature as referred to herein means the temperature of the cellulose acylate film that has been kept in contact with a contact vapor.

Preferably, the volumetric humidity in wet heat treatment is from 180 to 380 g/m³, more preferably from 200 to 350 g/m³, even more preferably from 220 to 340 g/m³.

Preferably in the production method for cellulose acylate film mentioned above, the volumetric humidity in wet heat treatment of a low-substitution cellulose acylate film (concretely, cellulose acylate film having a degree of acyl substitution of from 2.0 to 2.3, especially cellulose acetate film having a degree of acetyl substitution of from 2.0 to 2.3) is controlled to fall within the above range. For example, when a volumetric humidity condition most suitable for a cellulose acylate film having a degree of acyl substitution of about 2.9 or so is applied to such a low-substitution cellulose acylate film, then the film may be greatly stretched in the machine direction in the wet heat treatment step.

The vapor (contact vapor) to be kept in contact with the cellulose acylate film in the wet heat treatment step is a vapor containing water vapor, more preferably a vapor containing water vapor as the main ingredient thereof, even more preferably water vapor alone. The main ingredient of the vapor means that, when the vapor is a single vapor, the main ingredient is the single vapor itself, and when the vapor is composed of multiple vapors, the main ingredient is the vapor having the highest mass fraction of all the constitutive vapors.

Preferably, the contact vapor is formed in a wet vapor supply apparatus. Concretely, a solvent in the form of a solution is heated in a boiler to be a vapor, which is then fed via a blower. The contact vapor may be mixed with air, and after fed via a blower, it may be heated via a heating unit. In this, the air is preferably heated. Thus formed, the temperature of the contact vapor is preferably from 70 to 200° C., more preferably from 80 to 160° C., most preferably from 100 to 140° C. When the temperature is not higher than the uppermost limit, then it is favorable since the film is not too much curled; and when not lower than the lowermost limit, the contact vapor produces a sufficient effect.

Preferably, the relative humidity of the contact vapor is from 10% to 100%, more preferably from 15 to 100%, even more preferably from 20 to 100%.

Regarding the contact method between the cellulose acylate film and the above-mentioned contact vapor in the wet heat treatment step, employable is a method of applying the contact vapor to the cellulose acylate film, a method of putting the cellulose acylate film in a space filled with the contact vapor, or a method of leading the film to pass through the space filled with the contact vapor. Of those, preferred is the method of applying the contact vapor to the cellulose acylate film, or the method of leading the film to pass through the space filled with the contact vapor. Preferably, the cellulose acylate film is kept in contact with the contact vapor with the film kept guided in the contact zone by zigzag-arranged plural rollers therein.

The contact time with the contact vapor is not specifically defined. Within the range capable of attaining the effect of the invention, the contact time is preferably as short as possible from the viewpoint of the production efficiency. The uppermost limit of the processing time is, for example, preferably at most 60 minutes, more preferably at most 10 minutes. On the other hand, the lowermost limit of the processing time is, for example, preferably at least 10 seconds, more preferably at least 30 seconds.

Not specifically defined, the temperature of the cellulose acylate film before brought into contact with the contact vapor is preferably from 80 to 130° C.

Not specifically defined, the residual solvent amount in the cellulose acylate film before the wet heat treatment is preferably such that the cellulose acylate molecules have almost lost the flowability. Concretely, the residual solvent amount is preferably from 0 to 5% by mass, more preferably from 0 to 0.3% by mass.

After kept in contact with the cellulose acylate film, the contact vapor is fed to a condensation unit connected with a cooling unit, in which the contact vapor may be separated into a hot vapor and a condensate liquid.

Regarding the timing of the wet heat treatment step in the production method for cellulose acylate film mentioned above, the wet heat treatment step may be just after the stretching step or may be just after the drying step to be attained after the stretching step, or may also be after the step of once winding the film into a roll after the stretching step. In case where the film is processed for the wet heat treatment after it has been once wound up into a roll, it may be processed directly as it is in the form of a roll, or after it is again unwound into a film.

(7) Drying Step after Wet Heat Treatment:

The cellulose acylate film thus kept in contact with a contact vapor in the manner as above may be cooled to room temperature directly as it is, or for controlling the amount of the contact vapor molecules remaining in the film, the film may be subsequently conveyed into a drying zone. In case where the film is conveyed into a drying zone, there may be employed a method where hot air or warm air or air having a low vapor concentration is applied to the cellulose acylate film kept conveyed with rolls or the cellulose acylate film kept conveyed with both sides thereof clipped with a tenter, a method where the film is irradiated with heat rays, or a method where the film is kept in contact with heated rolls. Preferred is the method of applying hot air or warm air or air having a low vapor concentration to the film. In case where the water vapor contact step is taken before the heat treatment step, the heat treatment step may be the drying step.

(8) Heat Treatment Step after Wet Heat Treatment:

Preferably in the production method for the film of the invention, the wet heat treatment step is followed by the above-mentioned heat treatment step. In the invention, the heat treatment step may be attained after the wet heat treatment step and before the drying step; or after the wet heat treatment step, the drying step may serve also as the heat treatment step; or after the wet heat treatment step followed by the drying step, the film may be once wound up and may be thereafter processed for heat treatment in a separate step additionally provided in the method. Preferably in the invention, the heat treatment step is provided after the wet heat treatment step and before the drying step. This is because the mode is advantageous in point of producing a film having more excellent thermal dimensional stability.

The reason why the shrinkage of the film could be reduced through the treatment is not clear, but it may be presumed that, in the film stretched in the stretching step, the residual stress in the stretching direction is large and the residual stress is solved by the heat treatment whereby the contraction force of the film in the region not higher than the heat treatment temperature could be thereby reduced.

The heat treatment may be attained according to a method of applying air at a predetermined temperature to the film being conveyed, or a method of using a heating means such as microwaves, etc.

During drying by heat treatment, the volumetric humidity is preferably 0 g/m³. Preferably, the heat treatment temperature in the heat treatment step is the same as the temperature in the wet heat treatment step from the viewpoint of preventing dew condensation and preventing the film from shrinking.

In the heat treatment step, the film tends to shrink in the machine direction or in the lateral direction. It is desirable that the shrinkage of the film is prevented as much as possible during the heat treatment for bettering the surface smoothness of the finished film. For this, preferably employed is a method of heat-treating the film with clipping or pinning both sides of the film in the lateral direction to thereby secure the width of the film (tenter mode). Also preferably, the film is elongated by from 0.9 times to 1.5 times in both the lateral direction and the machine direction of the film.

### (9) Winding Step:

For winding up the produced film, an ordinary winder may be used, and the film may be wound up according to an ordinary winding method of a constant tension method, a constant torque method, a taper tension method or a programmed tension control method where the internal stress is kept constant. The optical film roll obtained in the manner as above is preferably such that the slow axis direction of the film is within ±2 degrees to the winding direction (machine direction of the film), more preferably within ±1 degree. Also preferably, the slow axis direction of the film is within ±2 degrees to the direction perpendicular to the winding direction (lateral direction of the film), more preferably within ±1 degree. Even more preferably, the slow axis direction of the film is within ±0.1 degrees to the winding direction (machine direction of the film), or it is within ±0.1 degrees to the lateral direction of the film.

Regarding the length thereof, the film thus produced in the manner as above is preferably wound up into a roll having a length of from 100 to 10000 m, more preferably from 500 to 7000 m, even more preferably from 1000 to 6000 m. The width of the film is preferably from 0.5 to 5.0 m, more preferably from 1.0 to 3.0 m, even more preferably from 1.0 to 2.5 m. In winding up the film, preferably, the film is knurled at least on one side thereof, and the knurling width is preferably from 3 mm to 50 mm, more preferably from 5 mm to 30 mm, and the knurling height is preferably from 0.5 to 500 μm, more preferably from 1 to 200 μm. The knurling may be in a mode of single pressing or double pressing.

The film of the invention is especially suitable for use in large-panel liquid crystal display devices. In case where the film is used as an optical compensatory film for large-panel liquid crystal display devices, preferably, the film is shaped to have a film width of, for example, at least 1470 mm. The optical compensatory film of the invention includes not only an embodiment of a film sheet cut in a size capable of being directly incorporated in a liquid crystal display device but also an embodiment of a film roll produced as a long film in continuous production and wound up into a roll. The optical compensatory film of the latter embodiment is stored and conveyed as it is, and when it is actually incorporated into a liquid crystal display device or when it is stuck to a polarizing element or the like, it may be cut into a sheet having a desired size. The film of the invention formed as a long film may be stuck, directly as it is, with a polarizing element formed of a polyvinyl alcohol film or the like similarly as a long film, and thereafter when the thus-stuck films are actually incorporated in a liquid crystal display device, they may be cut into a desired size. One embodiment of the optical compensatory film wound up in the form of a roll may have a roll length of at least 2500 m.

Thus produced, the film is wound up to give a final product, cellulose acylate film.

In the production method for the cellulose acylate film of the invention mentioned above, preferably, the thickness of the stretched film is controlled to fall within the range of the thickness of the cellulose acylate film of the invention. When thinner than 10 μm, the mechanical strength of the film may be low and the film may be broken or troubled in its production, and the film surface condition may be poor. The wet heat treatment effect is remarkable when the film thickness is within a range of from 15 to 45 μm.

The film thickness may be controlled to be a desired one by controlling the solid concentration in the dope, the slit gap of the die nozzle, the extrusion pressure from the die, the metal support speed, etc.

### [Polarizer]

The polarizer of the invention contains a polarizing element and at least one cellulose acylate film of the invention on at least one side of the polarizing element. Containing the cellulose acylate film of the invention, the polarizer of the invention is prevented from curling. The polarizer of the invention is described below.

Like the film of the invention, the polarizer of the invention also includes not only an embodiment of a film sheet cut in a size capable of being directly incorporated in a liquid crystal display device but also an embodiment of a film roll produced as a long film in continuous production and wound up into a roll (for example, an embodiment having a roll length of at least 2500 m or at least 3900 m). For use in large-panel liquid crystal display devices, the width of the polarizer is preferably at least 1470 mm, as so mentioned in the above. For the concrete constitution of the polarizer of the invention, any known constitution is employable with no limitation thereon. For example, the constitution described in FIG. 6 in JP-A 2008-262161 may be employed here.

[Liquid crystal Display Device]

The liquid crystal display device of the invention contains at least one polarizer of the invention. Comprising the polarizer of the invention that contains the cellulose acylate film of the invention, the liquid crystal display device of the invention is free from troubles of color shift and corner unevenness generation. In addition, preferably, the liquid crystal display device of the invention is improved in the front contrast thereof.

The liquid crystal display device of the invention comprises a liquid crystal cell and a pair of polarizers arranged on both sides of the liquid crystal cell, in which at least one polarizer is the polarizer of the invention. Preferably, the liquid crystal display device is an IPS, OCB or VA-mode liquid crystal display device.

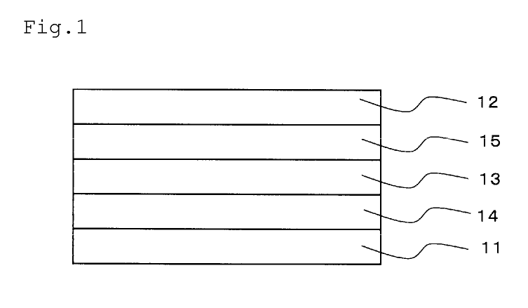

The concrete constitution of the liquid crystal display device of the invention is not specifically defined, and any known constitution is employable in the device. For example, one example of the constitution of the liquid crystal display device of the invention is shown in FIG. 1. In addition, the constitution described in FIG. 2 in JP-A 2008-262161 is also employable here.

### EXAMPLES

The invention is described more concretely with reference to the following Examples. In the following Examples, the material used, its amount and ratio, the details of the treatment and the treatment process may be suitably modified or changed not overstepping the sprit and the scope of the invention. Accordingly, the invention should not be limitatively interpreted by the Examples mentioned below.

### <<Measurement Methods>>

In the invention, the film samples were analyzed to measure their properties according to the following measurement methods.

### (Optical Expressibility)

Using KOBRA 21ADH (by Oji Scientific Instruments), Re and Rth of the samples are measured at a wavelength of 550 nm, according to the method mentioned above. The results are shown in Table 6 below.

### (Internal Haze)

A few drops of glycerin are applied onto both surfaces of the cellulose acylate film sample (having a size of 40 mm×80 mm) to be analyzed, the film is sandwiched between two glass plates (MICRO SLIDE GLASS Lot No. S9213, by Matsunami) each having a thickness of 1.3 mm, and at 25° C. and at a relative humidity of 60%, the haze value of the sample is measured with a haze meter (HGM-2DP, by Suga Test Instruments) according to JIS K-6714. On the other hand, a few drops of glycerin are put between two glass plates, and the haze value thereof is measured. The latter value is subtracted from the former value to give the internal haze value (%) of the film sample. The results are shown in Table 6 below.

### (Dimensional Change)

The dimensional change of a film sample before and after 24 hours at 60° C. and at a relative humidity of 90%, or that is, {(L′−L0)/L0}×100(%) is measured in the machine direction and in the direction perpendicular thereto. In this, L0 means the length (unit: mm) of the film before aged for 24 hours at 60° C. and at a relative humidity of 90%; and L′ means the length (unit: mm) of the film after aged for 24 hours at 60° C. and at a relative humidity of 90% and further after conditioned for 2 hours. The sample film has a size of 30 mm×120 mm, and the other condition is as mentioned below.

The film is conditioned in an atmosphere at 25° C. and at a relative humidity of 60% for 2 hours or more, then using an automatic pin gauge (by Shinto Scientific), 6 mmφ holes are formed in the film at intervals of 100 mm to be in parallel to the 120-mm side of the film, and the original dimension of the distance (L0) is measured to the minimum scale, 1/1000 mm. Then, after aged for 24 hours at 60° C. and at a relative humidity of 90%, the film is conditioned in an atmosphere at 25° C. and at a relative humidity of 60% for 2 hours, the dimension L′ of the distance between the holes is measured.

### A: Excellent.

### B: Good.

### C: Poor.

The results are shown in Table 6 below.

### Examples 1 to 20, and Comparative Examples 1 to 10

### (1) Preparation of Cellulose Acylate by Synthesis

Cellulose acylates each having the degree of acyl substitution shown in Table 6 were prepared. Concretely, as a catalyst, sulfuric acid (7.8 parts by mass relative to 100 parts by mass of cellulose) was added to cellulose, and each carboxylic acid was added thereto for acylation at 40° C. Subsequently, the total degree of substitution and the degree of 6-substitution were controlled by controlling the amount of the sulfuric acid catalyst, the amount of water and the aging time. The aging temperature was 40° C. The cellulose acylate was washed with acetone to remove the low-molecular component thereof.

### (2) Preparation of Dope

The following ingredients were put into a mixing tank and dissolved by stirring. The mixture was heated at 90° C. for about 10 minutes, and filtered through paper filter having a mean pore size of 34 μm and through a sintered metal filter having a mean pore size of 10 μm.

Cellulose Acylate Solution

| | |
|---|---|
| Cellulose Acylate shown in | 100.0 parts by mass in total |
| Table 6 below | |
| Additive 1 shown in Table 6 | (amount shown in Table 6, |
| below | unit: part by mass) |
| Additive 2 shown in Table 6 | (amount shown in Table 6, |
| below | unit: part by mass) |
| Methylene Chloride | 403.0 parts by mass |
| Methanol | 60.2 parts by mass |

The structures of the additives are shown below.

TABLE 5

| | | Dicarboxylic Acid Unit | | | | Glycol Unit | | | | |
|---|---|---|---|---|---|---|---|---|---|---|
| | | terephthalic | phthalic | | succinic | ethylene | | | | |
| | Molecular | acid | acid | adipic acid | acid | glycol | 1,2-propanediol | PG Ratio | | SP Value |
| Compound | Weight | (mol %) | (mol %) | (mol %) | (mol %) | (mol %) | (mol %) | [%] | End | [MPa^{1/2}] |
| E1 | 1000 | 0 | 0 | 60 | 40 | 100 | 0 | 0 | OH | 22.7 |
| E2 | 790 | 45 | 5 | 0 | 50 | 25 | 75 | 75 | OH | 23.2 |
| E3 | 800 | 55 | 0 | 0 | 45 | 50 | 50 | 50 | AC | 21.9 |

N1 (SP value, 21.73 MPa^{1/2}):

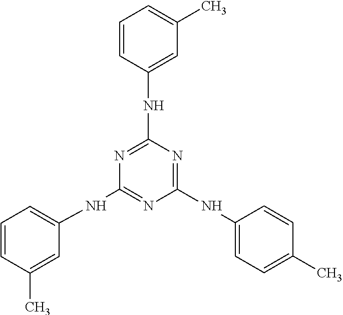

N2 (SP value, 22.22 MPa^{1/2}):

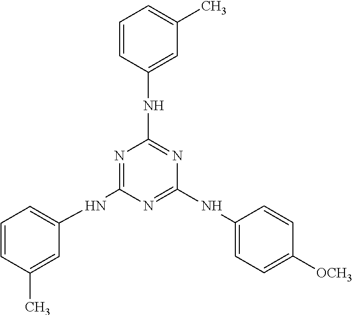

### <1-2> Mat Agent Dispersion:

Next, the following composition containing the cellulose acylate solution prepared in the above was put into a disperser to prepare a mat agent dispersion.

Mat Agent Dispersion

| | |
|---|---|
| Mat Agent (Aerosil R972) | 0.2 parts by mass |
| Methylene Chloride | 72.4 parts by mass |
| Methanol | 10.8 parts by mass |
| Cellulose Acylate Solution | 10.3 parts by mass |

100 parts by mass of the above-mentioned cellulose acylate solution was mixed with the mat agent dispersion in such a manner that the amount of the inorganic fine particles could be 0.02 parts by mass of the cellulose acylate, thereby preparing a dope for film formation.

### (3) Casting

The dope was cast, using a band caster. The band was made of SUS.

### (4) Drying

The web (film) obtained by casting was peeled from the band, and using a tenter for conveying the web by clipping it at both sides thereof, the web was dried in the tenter for 20 minutes.

### (5) Stretching

The formed web (film) was peeled from the band, clipped, and stretched under the condition of side-fixed monoaxial stretching, in the direction perpendicular to the machine direction (lateral direction) at the stretching temperature and the draw ratio indicated in Table 6 below, while the residual solvent amount was from 0 to 40% relative to the total mass of the film, using a tenter.

Subsequently, the film was unclipped and dried at 110° C. for 30 minutes. In this, the casting thickness was so controlled that the thickness (unit, μm) of the stretched film could be as in Table 6.

### (6) Wet Heat Treatment

The stretched film was processed for dew condensation prevention treatment, wet heat treatment (water vapor contact treatment) and heat treatment in series.

In the dew condensation prevention treatment, dry air was applied to the film to control the film temperature (100° C.) Tf0.

In the wet heat treatment (water vapor contact treatment), the absolute humidity of the wet vapor (volumetric humidity in wet heat treatment) inside the wet vapor contact chamber was controlled to be the value as in Table 6, and the dew point of the wet vapor was so controlled as to be higher by at least 10° C. than the film temperature Tf0. While the film temperature (wet heat treatment temperature) as shown in Table 6 was kept for the processing time (60 seconds), the film was conveyed through the chamber.

### (7) Drying and (8) Heat Treatment after Wet Heat Treatment

In the heat treatment, the absolute humidity of the vapor in the heat treatment chamber (volumetric humidity in heat treatment) was 0 g/m³, and the temperature of the film (heat treatment temperature) was set to be the same temperature as the wet heat treatment temperature, and the film was kept as such for the processing time (2 minutes). The film surface temperature was measured with tape-type thermocouple surface temperature sensors (Anritsu Meter's ST Series) stuck to three points of the film surface, and the data of the sensors were averaged.

### (9) Winding

Subsequently, the film was cooled to room temperature and wound up. For the purpose of determining the production aptitude of the film, at least 24 rolls of the film each having a roll width of 1280 mm and a roll length of 2600 mm were produced under the condition as above. Of those 24 rolls continuously produced, one roll was sampled at intervals of 100 m to give samples each having a length of 1 m (width of 1280 mm), and these were analyzed as films of Examples and Comparative Examples.

### (Production of Polarizer Sample)

The surface of the film produced in the above-mentioned Examples and Comparative Examples was alkali-saponified. Briefly, the film was dipped in an aqueous solution of sodium hydroxide (1.5 mol/L) at 55° C. for 2 minutes, then washed in a water-washing bath at room temperature, and neutralized with 0.1 N sulfuric acid at 30° C. Again this was washed in a water-washing bath at room temperature, and then dried with hot air at 100° C. Subsequently, a roll of polyvinyl alcohol film having a thickness of 80 μm was unrolled and continuously stretched by 5 times in an aqueous iodine solution and dried to give a polarizing element having a thickness of 20 μm. Using a 3% aqueous solution of polyvinyl alcohol (Kuraray's PVA-117H) as an adhesive, the alkali-saponified film of Examples and Comparative Examples was stuck to Fujitac TD80UL (by FUJIFILM) that had been alkali-saponified like in the above, with the polarizing element sandwiched therebetween in such as manner that the saponified surfaces of the two films could face the polarizing element side, thereby producing a polarizer in which the film of Examples and Comparative examples, the polarizing element, TD80UL were stuck together in that order. In this, the polarizing element and the films were so arranged that the MD direction of the film of Examples and Comparative Examples and the slow axis of TD80UL could be parallel to the absorption axis of the polarizing element.

### (Evaluation of Curling Resistance of Polarizer)

The polarizer of Examples and Comparative Examples produced in the above was evaluated for the curling resistance thereof based on the criteria mentioned below.

Briefly, the polarizer was blanked to give a 46-inch size sample, which was put on a flat desktop, and the maximum curling height of the polarizer was measured.

Based on the found data thereof, the sample was evaluated according to the criteria mentioned below.

A: from 0 to 5 mm.
B: from 5 to 20 mm.
C: More than 20 mm.

The results are shown in Table 6 below.

### (Production of Liquid Crystal Display Device)

The polarizers and the retardation films on the front side and the rear-side of a VA-mode liquid crystal TV (LC-46LX1, by Sharp) were peeled away from the device to prepare a liquid crystal cell for use herein. As in FIG. 1 (in this, the upper side is the front side), an outer protective film (not shown), a polarizing element 11, a film 14 of Examples and Comparative Examples shown in Table below (rear-side cellulose acylate film), a liquid crystal cell 13 (the above-mentioned VA liquid crystal cell), a film 15 of Examples and Comparative Examples shown in Table below (front-side cellulose acylate film), a polarizing element 12 and an outer protective film (not shown) were stuck together with an adhesive in that order, thereby producing a liquid crystal display device of Examples and Comparative Examples. In this, the polarizers were so arranged that the absorption axes of the upper and lower polarizers could be perpendicular to each other.

### (Front Contrast)

Using a measuring instrument (BMSA, by TOPCON), the brightness of the display device was measured in a dark room at the time of black level and white level of display in the panel front direction, and the front contrast (white-level brightness/black-level brightness) of the device was computed from the found data.

The contrast data were evaluated according to the following criteria.

A: more than 6500.
B: from 5000 to 6500.
C: less than 5000.

The results are shown in Table 6 below.

### (Color Shift)

### (Color Shift in Viewing Angle (Polar Angle) Direction)

At the time of black level of display, the viewing angle to the device was tilted in the direction of the centerline (azimuth angle 45 degrees) of the transmission axes of the pair of polarizers from the normal direction of the liquid crystal cell, and the chromaticity change, Δxθ and Δyθ, was measured at a polar angle of from 0 to 80 degrees. Δxθ=xθ−xθ₀, Δyθ=yθ−θ₀, (xθ₀, yθ₀) is the chromaticity measured in the normal direction to the liquid crystal cell at the time of black level of display, and (xθ, yθ) is the chromaticity measured in the viewing angle direction tilted to the polar angle, θ degree in the direction of the centerline of the transmission axes of the pair of polarizers from the normal direction of the liquid crystal cell at the time of black level of display.

The results were evaluated according to the following criteria. The obtained evaluation is shown in Table 6 below.

A: Δxθ and Δyθ are both 0.03 or less.
B: Δxθ and Δyθ are both 0.05 or less.
C: Δxθ and Δyθ are both 0.1 or more.

### (Corner Unevenness)

For display performance evaluation of the liquid crystal display device, the corner unevenness was determined under the condition mentioned below.

The produced liquid crystal display device was left at 60° C. and at a relative humidity of 90% for 240 hours, then conditioned at 25° C. and at a relative humidity of 60% for 24 hours, and the display device was visually checked for corner unevenness at the time of black level of display.

Thus observed, the corner unevenness level was evaluated according to the following criteria:

### A: Good.

B: Some corner unevenness found.
C: More corner unevenness found.
D: Extreme corner unevenness found.

The results are shown in Table 6 below.

TABLE 6

| | Film Production Method | | | | | | | | | | | |
|---|---|---|---|---|---|---|---|---|---|---|---|---|
| | | | | | | ΔSp Value | | | | | | |
| | | | | | | between | | | | | | |
| | | | Additive 1 | | | cellulose | | | | | Wet Heat Treatment | |
| | Cellulose Acylate | | | | SP | acylate and | Additive 2 | | Stretching | | | Absolute |
| | Total Degree of | SP Value | | Amount | Value | additive 1 | | Amount | Temperature | Draw | Temperature | Humidity |
| | Acyl Substitution | [MPa^{1/2}] | Type | [part by Mass] | [MPa^{1/2}] | [MPa^{1/2}] | Type | [part byMass] | [° C.] | Ratio [%] | [° C.] | [%] |
| Comparative Example 1 | 2.00 | 24.0 | E2 | 10.0 | 23.2 | 0.9 | — | — | 150 | 25 | 100 | 230 |
| Example 1 | 2.12 | 23.7 | E2 | 10.0 | 23.2 | 0.5 | — | — | 150 | 27 | 100 | 230 |
| Example 2 | 2.20 | 23.5 | E2 | 10.0 | 23.2 | 0.3 | — | — | 150 | 30 | 100 | 230 |
| Example 3 | 2.28 | 23.3 | E2 | 10.0 | 23.2 | 0.1 | — | — | 150 | 32 | 100 | 230 |
| Comparative Example 2 | 2.35 | 23.1 | E2 | 10.0 | 23.2 | −0.1 | — | — | 150 | 35 | 100 | 230 |
| Comparative Example 3 | 212 | 23.7 | E2 | 10.0 | 23.2 | 0.5 | N2 | 4 | 150 | 27 | 100 | 230 |
| Example 4 | 2.12 | 23.7 | E2 | 10.0 | 23.2 | 0.5 | N2 | 4 | 150 | 27 | 100 | 230 |
| Example 5 | 2.12 | 23.7 | E2 | 10.0 | 23.2 | 0.5 | N2 | 4 | 150 | 27 | 100 | 230 |
| Example 6 | 2.12 | 23.7 | E2 | 10.0 | 23.2 | 0.5 | — | — | 150 | 27 | 100 | 230 |
| Example 7 | 2.12 | 23.7 | E2 | 10.0 | 23.2 | 0.5 | — | — | 150 | 25 | 100 | 230 |
| Example 8 | 2.12 | 23.7 | E2 | 10.0 | 23.2 | 0.5 | — | — | 150 | 23 | 100 | 230 |
| Comparative Example 4 | 2.12 | 23.7 | E2 | 10.0 | 23.2 | 0.5 | — | — | 150 | 20 | 100 | 230 |
| Comparative Example 5 | 2.12 | 23.7 | E2 | 10.0 | 23.2 | 0.5 | — | — | 150 | 15 | 100 | 230 |
| Example 9 | 2.12 | 23.7 | E2 | 10.0 | 23.2 | 0.5 | — | — | 150 | 22 | 100 | 230 |
| Example 10 | 2.12 | 23.7 | E2 | 10.0 | 23.2 | 05 | — | — | 150 | 25 | 100 | 230 |
| Example 11 | 2.12 | 23.7 | E2 | 10.0 | 23.2 | 0.5 | — | — | 150 | 27 | 100 | 230 |
| Comparative Example 6 | 2.12 | 23.7 | E2 | 10.0 | 23.2 | 0.5 | — | — | 150 | 35 | 100 | 230 |
| Comparative Example 7 | 2.12 | 23.7 | E2 | 10.0 | 23.2 | 0.5 | | | 180 | 27 | 100 | 230 |
| Example 12 | 2.12 | 23.7 | E2 | 10.0 | 23.2 | 0.5 | | | 165 | 27 | 100 | 230 |
| Example 13 | 2.12 | 23.7 | E2 | 10.0 | 23.2 | 05 | N2 | 4 | 135 | 27 | 100 | 230 |
| Comparative Example 8 | 212 | 23.7 | E2 | 10.0 | 232 | 0.5 | N2 | 8 | 135 | 27 | 100 | 230 |
| Example 14 | 2.12 | 23.7 | E1 | 10.0 | 22.7 | 1.0 | — | — | 150 | 27 | 100 | 230 |
| Example 15 | 2.12 | 23.7 | E3 | 10.0 | 21.9 | 1.7 | — | — | 150 | 27 | 100 | 230 |
| Example 16 | 2.12 | 23.7 | E2 | 10.0 | 23.2 | 0.5 | N1 | 4 | 150 | 27 | 100 | 230 |
| Example 17 | 2.12 | 23.7 | E2 | 10.0 | 23.2 | 0.5 | N2 | 4 | 150 | 27 | 100 | 230 |
| Example 18 | 2.12 | 23.7 | E2 | 10.0 | 23.2 | 0.5 | — | — | 135 | 27 | 100 | 230 |
| Example 19 | 2.12 | 23.7 | E2 | 10.0 | 23.2 | 0.5 | — | — | 160 | 27 | 100 | 230 |
| Example 20 | 2.12 | 23.7 | E2 | 10.0 | 23.2 | 0.5 | — | — | 185 | 27 | 100 | 230 |
| Comparative Example 9 | 2.12 | 23.7 | — | 10.0 | — | — | — | — | 150 | 27 | 100 | 230 |
| Comparative Example 10 | 2.12 | 23.7 | TPP | 10.0 | 20.6 | 3.1 | — | — | 150 | 27 | 100 | 230 |
| Example 21 | 2.20 | 23.5 | Sugar 1 | 10.0 | 22.0 | 1.5 | — | — | 150 | 28 | 100 | 230 |
| Example 22 | 2.20 | 23.5 | Sugar 2 | 10.0 | 22.3 | 1.2 | — | — | 150 | 26 | 100 | 230 |
| Example 23 | 2.2(Ac/Pr = 1.6/06) | 23.0 | E2 | 10.0 | 23.2 | −0.2 | — | — | 150 | 30 | 100 | 240 |
| Example 24 | 2.12 | 23.7 | E2 | 8.0 | 23.2 | 0.5 | — | — | 190 | 25 | 100 | 230 |

| | Film Properties | | | | | | | | |
|---|---|---|---|---|---|---|---|---|---|
| | | Optical Characteristics | | | | | | | |
| | | | | Internal | Dimensional | Polarizer | Display Device | | |
| | Thickness | Rc | Rth | Haze | Change | Curling | | Color | Corner |
| | [μm] | [nm] | [nm] | [%] | MD, TD | Resistance | Contrast | Shift | Unevenness |
| Comparative Example 1 | 30 | 59 | 210 | 0.02 | C | C | A | A | B |
| Example 1 | 30 | 58 | 170 | 0.03 | B | A | A | A | A |
| Example 2 | 30 | 65 | 160 | 0.03 | A | A | A | A | A |
| Example 3 | 30 | 55 | 130 | 0.02 | A | A | A | A | A |
| Comparative Example 2 | 25 | 55 | 90 | 0.02 | B | A | C | C | D |
| Comparative Example 3 | 5 | Broken | | | | — | — | — | — |
| Example 4 | 12 | 45 | 102 | 0.03 | A | A | A | A | B |
| Example 5 | 18 | 48 | 120 | 0.03 | A | A | A | A | B |
| Example 6 | 30 | 55 | 130 | 0.03 | A | A | A | A | A |
| Example 7 | 35 | 65 | 158 | 0.03 | A | A | A | A | B |
| Example 8 | 40 | 55 | 180 | 0.03 | B | A | A | A | C |
| Comparative Example 4 | 48 | 55 | 201 | 0.03 | B | A | A | C | D |
| Comparative Example 5 | 30 | 35 | 150 | 0.04 | B | A | C | C | B |
| Example 9 | 30 | 45 | 155 | 0.02 | B | A | A | A | B |
| Example 10 | 30 | 66 | 164 | 0.02 | B | A | A | A | B |
| Example 11 | 30 | 59 | 172 | 0.02 | B | A | A | A | B |
| Comparative Example 6 | 30 | 65 | 178 | 0.10 | B | A | C | C | B |
| Comparative Example 7 | 30 | 50 | 80 | 0.02 | B | A | C | C | B |
| Example 12 | 30 | 51 | 120 | 0.02 | B | A | A | A | B |
| Example 13 | 30 | 52 | 280 | 0.02 | B | A | A | A | B |
| Comparative Example 8 | 40 | 56 | 320 | 0.02 | B | A | B | C | B |
| Example 14 | 30 | 50 | 110 | 0.04 | B | A | A | A | B |
| Example 154 | 30 | 51 | 120 | 0.06 | B | A | B | A | B |
| Example 16 | 30 | 52 | 150 | 0.01 | B | A | A | A | B |
| Example 17 | 30 | 54 | 152 | 0.01 | B | A | A | A | B |
| Example 18 | 30 | 61 | 220 | 0.05 | B | A | A | A | B |
| Example 19 | 30 | 61 | 115 | 0.04 | B | A | A | A | B |
| Example 20 | 30 | 52 | 102 | 0.01 | B | A | A | A | B |
| Comparative Example 9 | 30 | Broken | | | | — | — | — | — |
| Comparative Example 10 | 30 | 55 | 130 | 0.25 | B | A | C | A | B |
| Example 21 | 30 | 55 | 105 | 0.02 | B | A | A | A | B |
| Example 22 | 30 | 55 | 124 | 0.01 | B | A | A | A | B |
| Example 23 | 42 | 50 | 120 | 0.02 | B | A | A | A | B |
| Example 24 | 30 | 52 | 115 | 0.03 | B | A | B | A | B |

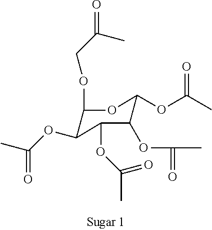

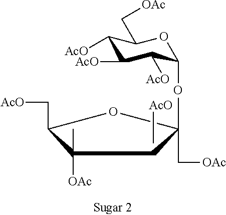

From the above Table 6, it is known that the films of Examples all have the desired optical expressibility even though thin, and when actually incorporated in polarizer, they are fully resistant to curling, and when actually incorporated in liquid crystal display device, they fully solve the problem of color shift and corner unevenness.

On the other hand, in the film of Comparative Example 1; the total degree of acyl substitution of the cellulose acylate is lower than the lower limit in the invention, and it is known that the film curls when actually incorporated in polarizer. In the film of Comparative Example 2, the total degree of acyl substitution of the cellulose acylate is higher than the higher limit in the invention, and it is known that Rth of the film is low and, when actually incorporated in liquid-liquid crystal display device, the film could not solve the problem of color shift and corner unevenness. In Comparative Example 3, the film was tried but in vain, in which the film thickness was lower than the lower limit of the range in the invention, and it is known that the film is broken. In Comparative Example 4, the thickness of the film is more than the higher limit of the range in the invention, and it is known that, when actually incorporated in liquid crystal display device, the film could not solve the problem of color shift and corner unevenness. In Comparative Examples 5 and 6, Re of the film falls outside the scope of the invention, and it is known that, when actually incorporated in liquid crystal display device, the film could not solve the problem of color shift. In Comparative Examples 7 and 8, Rth of the film falls outside the scope of the invention, and it is known that, when actually incorporated in liquid crystal display device, the film could not solve the problem of color shift.

In Comparative Example 9, the film does not contain a plasticizer, and the film broke when stretched.

In Comparative Example 10, the film does not contain a non-phosphate additive, and it is known that the film whitens.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2011-095486, filed on Apr. 21, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A cellulose acylate film, which comprises a cellulose acylate having a total degree of substitution of from 2.1 to 2.3 and a non-phosphate compound, which satisfies the following formulae (1) and (2), and which has a thickness of from 10 μm to 45 μm:
40 nm≦Re(550)≦60 nm (1)
wherein Re(550) means the in-plane retardation of the film at a wavelength of 550 nm,
100 nm≦Re(550)≦300 nm (2)
wherein Rth(550) means the thickness-direction retardation of the film at a wavelength of 550 nm.

2. The cellulose acylate film according to claim 1, having a thickness of from 15 μm to 30 μm.

3. The cellulose acylate film according to claim 1, of which the absolute value of the dimensional change satisfies the following formula (3):

|{(L′−L0)/L0}×100%|≦0.5% (3)
wherein L0 means the length (unit: mm) of the film before aged for 24 hours at 60° C. and at a relative humidity of 90%; and L′ means the length (unit: mm) of the film after aged for 24 hours at 60° C. and at a relative humidity of 90% and further after conditioned for 2 hours.

4. The cellulose acylate film according to claim 1, wherein the absolute value of the difference between the SP value of the cellulose acylate and the SP value of the non-phosphate compound is at most 1.5 MPa^{1/2} and wherein the SP value indicates the solubility parameter measured according to a Hoy method.

5. The cellulose acylate film according to claim 1, comprising a hydrophobizing agent as the non-phosphate compound.

6. The cellulose acylate film according to claim 5, comprising a sugar as the hydrophobizing agent.

7. The cellulose acylate film according to claim 5, comprising a polycondensate ester compound as the hydrophobizing agent.

8. The cellulose acylate film according to claim 7, wherein the polycondensate ester compound has a number-average molecular weight of from 300 to less than 2000.

9. The cellulose acylate film according to claim 5, comprising a nitrogen-containing compound as the hydrophobizing agent.

10. The cellulose acylate film according to claim 5, wherein the non-phosphate compound is represented by the following formula:
B¹-(G¹-A¹)n-G¹-B¹ (2)
wherein B¹ represents a benzenemonocarboxylic acid residue; G¹ represents an alkylene glycol residue having from 2 to 12 carbon atoms, or an arylglycol residue having from 6 to 12 carbon atoms, or an oxyalkylene glycol residue having from 4 to 12 carbon atoms; A¹ represents an alkylenedicarboxylic acid residue having from 4 to 12 carbon atoms, or an aryldicarboxylic acid residue having from 6 to 12 carbon atoms; and n indicates an integer of 1 or more.

11. The cellulose acylate film according to claim 1, which comprises the non-phosphate compound in an amount of at most 35% by mass of the cellulose acylate in the film.

12. The cellulose acylate film according to claim 1, wherein the cellulose acylate has a total degree of substitution of 2.15 to 2.25.

13. The cellulose acylate film according to claim 1, wherein the cellulose acylate is a cellulose acetate.

14. The cellulose acylate film according to claim 1, stretched at a stretching temperature of from 130 to 195° C.

15. The cellulose acylate film according to claim 1, stretched at a draw ratio falling within a range of from more than 15% to less than 35%.

16. The cellulose acylate film according to claim 1, processed for wet heat treatment at a wet heat treatment temperature of from 80 to 120° C. and at an absolute humidity of from 150 to 380 g/m³.

17. The cellulose acylate film according to claim 1, which satisfies the following formula:
48 nm≦Re(550)≦60 nm

18. The cellulose acylate film according to claim 1, which satisfies the following formula:
110 nm≦Rth(550)≦250 nm

19. A polarizer comprising a polarizing element and a cellulose acylate film on at least one side of the polarizing element, wherein the cellulose acylate film comprises a cellulose acylate having a total degree of substitution of from 2.1 to 2.3 and a non-phosphate compound, which satisfies the following formulae (1) and (2), and which has a thickness of from 10 μm to 45 μm:
40 nm≦Re(550)≦60 nm (1)
wherein Re(550) means the in-plane retardation of the film at a wavelength of 550 nm,
100 nm≦Re(550)≦300 nm (2)
wherein Rth(550) means the thickness-direction retardation of the film at a wavelength of 550 nm.

20. A liquid crystal display device comprising a polarizer comprising a polarizing element and a cellulose acylate film on at least one side of the polarizing element, wherein the cellulose acylate film comprises a cellulose acylate having a total degree of substitution of from 2.1 to 2.3 and a non-phosphate compound, which satisfies the following formulae (1) and (2), and which has a thickness of from 10 μm to 45 μm:
40 nm≦Re(550)≦60 nm (1)
wherein Re(550) means the in-plane retardation of the film at a wavelength of 550 nm,
100 nm≦Re(550)≦300 nm (2)
wherein Rth(550) means the thickness-direction retardation of the film at a wavelength of 550 nm.
